(19) United States
(12) Patent Application Publication
(10) Pub. No.: US 2012/0130823 A1
(43) Pub. Date: May 24, 2012

(54) MOBILE MATCHING SYSTEM AND METHOD

(76) Inventor: Stephen P. Levin, New York, NY (US)

(21) Appl. No.: 13/299,234

(22) Filed: Nov. 17, 2011

Related U.S. Application Data
(60) Provisional application No. 61/415,184, filed on Nov. 18, 2010.

(51) Int. Cl. G06Q 30/02; G06F 15/16

(52) U.S. Cl. 705/14.69; 709/206; 709/204; 705/14.4

(57) ABSTRACT

A system and method for matching is disclosed. User profile information, location information and event information are stored in a database. First and second electronic check-in information representing that a first user and a second user have checked-in to an event is received and stored. User profile information of the two users is matched and a notification of the match is transmitted to at least one of the users. A response to the notification is received that indicates a request for a meeting between the first user and the second user, and a notification representing the request is sent to the user(s).

### RELATED APPLICATION

This application is based on and claims priority to U.S. Provisional Application Ser. No. 61/415,184, filed on Nov. 18, 2010 and entitled “MOBILE MATCHING SYSTEM AND METHOD,” the entire contents of which are hereby incorporated by reference.

### BACKGROUND

1. Field

The present invention relates, generally, to networks and, more particularly, to a social network that creates new connections between users not previously connected.

2. Related Art

Social networking is among the fastest growing areas of the Internet and the world wide web. Smartphones are among the fastest growing segments of the mobile market, and location-based services are among the hottest Internet concepts.

As popular as social networks and location-based services are becoming on mobile devices, social networks are focused on communicating with a user's existing network whether through consuming other members' updates or generating one's own.

Currently, communicating with one's existing network via a smartphone or other mobile device is effectively a mobile extension of existing social networking sites. Even location-based check-in applications are focused on in-network communications, which is essentially nothing more than an easier way to say, “Steve was here” or other message. There are some rudimentary attempts to interact with users, however these interactions are generic in nature, such as to check in and receive an offer or at best check in a lot and receive a better offer.

Further, meeting people in social situations currently, such as in bars, at parties, coffee shops, or the like as well as networking in business settings such as conventions, trade shows and networking events is frequently “hit or miss.” Currently, such meetings are random, in social situations based largely on physical attraction and confidence, and are largely ineffective for many people.

### SUMMARY

In accordance with an embodiment, a platform is provided that allows a user to interact with others in the real world, in real time and based on, for example, common interests. The platform leverages detailed online profiles, a matching algorithm, and cellular, Wi-Fi, GPS, and other positioning technology based check-in systems on mobile computing platforms (e.g., smartphones, tablets, laptops, or the like) to generate real-time connections with new people or products in the real world at a user's current location. Another embodiment is that detailed profile information is not made publicly viewable. This places the teachings herein in contrast with traditional social networking sites. Only minimum information necessary to justify a match may be displayed to a user. Connections with traditional social networks, however, may be supported.

Unlike known social networks, the present application generates value for participants while still maintaining and valuing user privacy. Instead of broadcasting someone's location to his/her social network, the system matches your profile and “introduces” the person to other individuals at his/her location, privately and in real time.

In accordance with an embodiment, a matching method and system is provided that includes storing in at least one database accessible to at least one information processor, user profile information representing at least a plurality of respective users. Additionally, location information representing at least one respective location is stored in the at least one database. Moreover, first electronic check-in information is received from a first computing device associated with a first user, that represents that the first user has checked-in to a first of the at least one respective location. The first electronic check-in information associated with the first user is stored in the at least one database. Second electronic check-in information is received, from a second computing device associated with a second user, that represents that the second user has checked-in to the first of the at least one respective location. The second electronic check-in information is stored in the at least one database. The at least one information processor matches first user profile information associated with the first user and second user profile information associated with the second user as a function of at least the first of the at least one respective location and the first and second user profile information. The at least one information processor transmits to one of the first computing device and the second computing device, a notification of the match.

In an alternative embodiment, user profile information representing at least a plurality of respective users is stored in at least one database accessible to at least one information processor. Further, location information representing one or more respective locations is stored in the at least one database. Moreover, event information representing a plurality of respective events, wherein each of the plurality of events is respectively associated with at least one of the one or more respective locations is stored in at least one database. First electronic check-in information is received from a first computing device associated with a first user, that represents that the first user has checked-in to a first of the plurality of respective events. The first electronic check-in information is stored in the at least one database. Second electronic check-in information is received from a second computing device that is associated with a second user, that represents that the second user has checked-in to the first of the plurality of respective events. The second electronic check-in information is stored in the at least one database. The at least one information processor matches first user profile information associated with the first user and second user profile information associated with the second user as a function of at least the first of the plurality of respective events and the first and second user profile information. The at least one information processor transmits to one of the first computing device and the second computing device, a notification of the match.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates a hardware arrangement, in accordance with an embodiment of the present application;

FIG. 2 illustrates functional elements, of which one or more may be configured in an computing device, in accordance with an embodiment;

FIG. 3 is a block diagram that illustrates a high level overview of interaction between users, in accordance with an embodiment.

FIG. 4 shows a block diagram that includes a plurality of users communicating over a communication network, in accordance with an embodiment.

FIG. 5A is a block diagram that includes an Event Manager and a plurality of users communicating over a communication network, in accordance with an embodiment.

FIG. 5B is a block diagram that includes a plurality of advertisers and users communicating over a communication network, in accordance with an embodiment.

FIG. 6 is a flow chart identifying initial steps that a user takes through their first match, in accordance with an embodiment.

FIG. 7 is another flow chart identifying initial steps that the system takes in response to a user from initial registration through their first match, in accordance with an embodiment.

FIG. 8 illustrates steps associated with use of an embodiment after a user has logged in, in accordance with an embodiment.

FIG. 9A illustrates a display “home” screen, in accordance with an embodiment.

FIG. 9B illustrates a log-in display screen provided on mobile user workstation in accordance with an embodiment.

FIGS. 10A and 10B illustrate a user profile data entry display screen, in accordance with an embodiment.

FIG. 11 illustrates a notification display screen in connection with completing a user registration, in accordance with an embodiment.

FIG. 12A illustrates a user display screen in connection with a successful user log-in, in accordance with an embodiment.

FIG. 12B includes a display screen provided on mobile user workstation for registering in accordance with an embodiment.

FIGS. 12C and 12D illustrate a combined view profile and edit profile display screen provided on mobile user workstation in accordance with an embodiment.

FIG. 13 illustrates an add places display screen in accordance with adding a new location, in accordance with an embodiment.

FIG. 14 illustrates another add places display screen in accordance with adding a new location, in accordance with an embodiment.

FIG. 15A illustrates a display screen illustrating a confirmation that a location was successfully added, in accordance with an embodiment.

FIG. 15B illustrates a display screen in accordance with adding a new location, in accordance with an embodiment.

FIG. 16 illustrates an add event display screen in accordance with adding a new event, in accordance with an embodiment.

FIG. 17 illustrates an add event display screen for selecting a location for a new event, in accordance with an embodiment.

FIG. 18 illustrates another add event display screen in accordance with adding a new event, in accordance with an embodiment.

FIG. 19A illustrates a display screen illustrating a confirmation that an event was successfully added, in accordance with an embodiment.

FIG. 19B illustrates an add event display screen in accordance with adding a new event via mobile user workstation, in accordance with an embodiment.

FIG. 20 illustrates a display screen illustrating a find event selection, in accordance with an embodiment.

FIG. 21 illustrates a display screen provided on a mobile user workstation that illustrates events and locations that are near a user, in accordance with an embodiment.

FIG. 22A illustrates a display screen provided on a mobile user workstation that represents a location, in accordance with an embodiment.

FIG. 22B illustrates a display screen provided on a mobile user workstation that represents a location with an event presently occurring, in accordance with an embodiment.

FIG. 23 illustrates a display screen provided on a mobile user workstation that provides event details, in accordance with an embodiment.

FIG. 24 illustrates a matches-list display screen provided on a mobile user workstation, in accordance with an embodiment.

FIGS. 25A and 25B illustrate a match detail display screen that are provided in combination on mobile user workstation in accordance with an embodiment.

### DESCRIPTION OF EMBODIMENTS

The present application (e.g., “embodiments”) relates to a social networking service that operates differently from known social networks. Referred to herein, generally as “Mobile Match” and/or “Herematch” the embodiments match a user's profile to other profiles in the system the user does not already know, and a platform is provided which allows a user to interact with new people in the real world in real time based on common interests. In other words, the embodiments relate to expanding a user's real world network by leveraging modern technology.

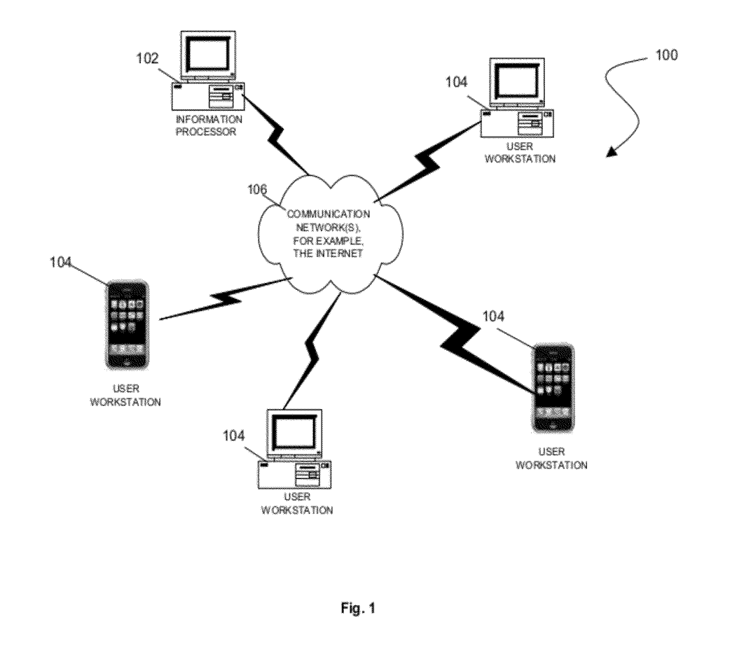

Referring now to the drawing figures, in which like reference numerals represent like elements, FIG. 1 illustrates a hardware arrangement in accordance with an embodiment of the present application. Referred to generally, herein, as system 100, the arrangement provides for monitoring and notification services in accordance with an embodiment. System 100 includes at least one information processor 102 (configured to operate as an Internet web server and/or database file server) that is programmed and configured to access communication network 106 and communicate with computing device(s) 104. Computing devices 104 may be personal computers, and may further be mobile devices, such as operating one or more of the GOOGLE ANDROID, APPLE IOS, WINDOWS MOBILE operating systems, and may include smartphone devices, tablet computing devices, other mobile portable devices. Computing devices 104 and information processor(s) 102 may communicate via the known communications protocol, Transmission Control Protocol/Internet Protocol “TCP/IP.” Information processor 102 and computing device(s) 104 preferably are provided with or have access to all databases necessary to support the present application.

Communication network 106 is preferably a global public communication network such as the Internet, but can also be a wide area network (WAN), local area network (LAN), an intranet or other network that enables computing devices and peripheral devices to communicate.

In a preferred embodiment, information processor(s) 102 and computing devices 104 may be equipped with web browser software, such as MICROSOFT INTERNET EXPLORER, MOZILLA FIREFOX, APPLE SAFARI or the like. Information processor 102 and computing devices 104 are coupled to communication network 106 using any known data communication networking technology.

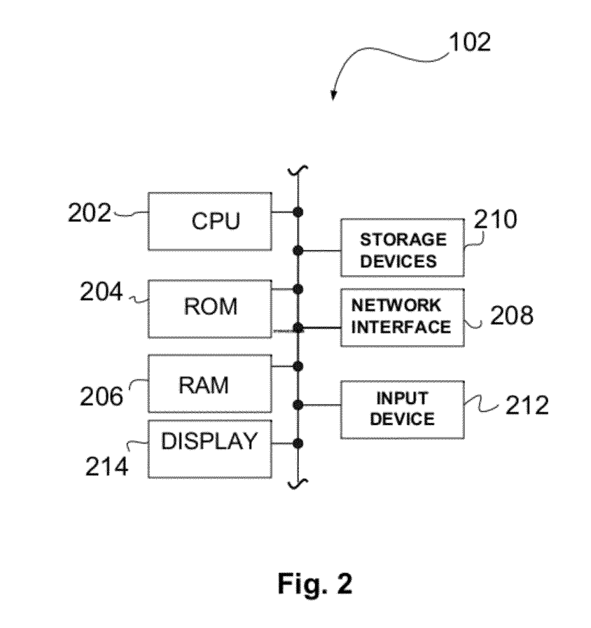

FIG. 2 illustrates functional elements, of which one or more may be configured in information processor 102 and/or computing device 104. The functional elements shown in FIG. 2 include one or more central processing units (CPU) 202 used to execute software code and control operations. Other elements shown in FIG. 2 include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components illustrated in FIG. 2 need not be physically contained within a single device chassis or even located in a single location. For example, storage device 210 may be located at a site that is remote from the remaining elements of information processor 102, and may even be connected to CPU 202 across communication network 106 via network interface 208. Information processor 102 and/or computing device 104 may include a memory equipped with sufficient storage, such as to provide or access the necessary databases, forums, and other community services communicating hypertext markup language (HTML), Java applets, Active-X control programs. Information processor 102 and/or computing device 104 are arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the present application is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and RUBY ON RAILS.

Although the present application is described by way of example herein and in terms of a web-based system using web browsers and a web site server (e.g., information processor 102), system 100 is not limited to such a configuration. It is contemplated that system 100 is arranged such that information processor 102 and/or computing devices 104 communicate with and outputs data using any known communication method, for example, using a non-Internet browser WINDOWS viewer coupled with a local area network protocol such as the Internet Packet Exchange (IPX), dial-up, third-party, private network or a value added network (VAN). Moreover, information processor 102 and/or computing devices 104 may communicate via an application developed to run on the iOS or ANDROID operating systems.

It is further contemplated that any suitable operating system can be used on information processor 102 and/or computing device 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, MAC OS, UNIX, LINUX, PALM OS, POCKET PC, BLACKBERRY, ANDROID, MS, WEB OS and any other suitable operating system.

Preferably, applications are provided in two different “flavors”—matching users to users, and matching users to products/offers.

User-To-User Systems may include one or more of the following: Dating/Personal Networking (also referred to herein, generally, as “SocialTap” and “CollegeTap”); and Business Networking (also referred to herein, generally, as “BusinessTap”).

Dating/Personal Networking (SocialTap & CollegeTap)—These features may allow individuals to create a profile (or upload or otherwise use a profile from another source, such as a social networking site, e.g., FACEBOOK). In addition, individuals can add interests or activities they take part in. In at least one embodiment (for example, CollegeTap), information such as class schedule, dormitory information, academic major, or the like may be included. Once the profile is created, users can use their mobile device to check in at locations. Upon checking in, they may be matched to similar users checked in at the same location. These matches may be displayed on each user's mobile device. They may include a minimum amount of information to identify the matching user and confirm the match. Communication options may be provided to facilitate real world connections. In at least one embodiment, this system supports people who move to new locations. It is particularly useful to a group of people who all move to a new location in a constrained geographic and temporal proximity such as incoming college freshmen.

Business Networking (BusinessTap)—This feature allows individuals to create a profile (or upload or otherwise use a profile from another source, such as a social networking site, e.g., LINKEDIN). In addition, individuals can add networks they belong to. These networks may include High Schools, their Colleges, their Fraternities, or the like. These networks may or may not include groups of people that users are connected to, but may be categories that users belong to and might have in common with other strangers in the room. This supports, for example, business people involved in physical networking, such as Chamber of Commerce networking events, conferences, trade shows, or the like. In an embodiment, a tool is provided which introduces them to each other enhances the purpose of their physical activity.

User-To-Product Systems may include features for matching offers to profiles rather than profiles to each other. For example, a store offers all sorts of clothing. A user's profile says he likes sweaters. Thereafter, the user's screen displays an image of a new (or on sale) sweater. Thereafter, the user goes to the grocery store. His profile says he buys eggs. An offer from an egg producer pops up advertising their eggs for less than their competitors. These apps may be provided from the User-To-User system profiles, as a separate system, or as unique offerings to various retail outlets (private labeled clubs) and may include store specific and generic shopping.

The present application includes:

Focusing on the difference between social networking on the web and social networking on the phone—variable location updated in real time (or substantially in real time).

Combining the power of location-based system check-ins with detailed profiles to allow users to interact with individuals and entities outside of their existing networks.

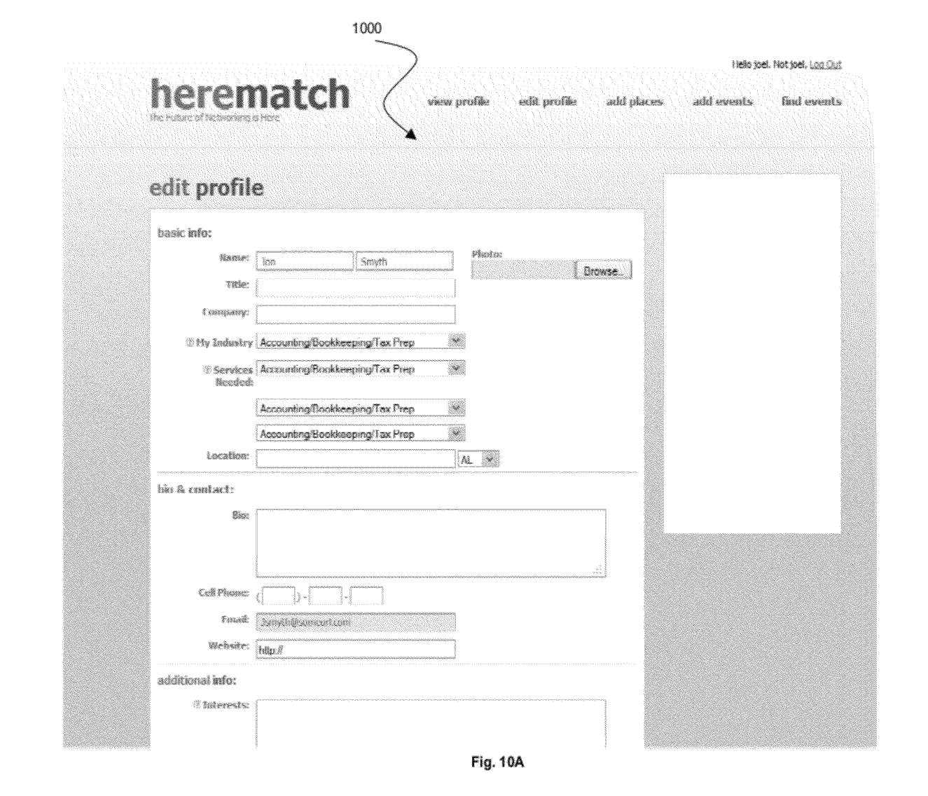

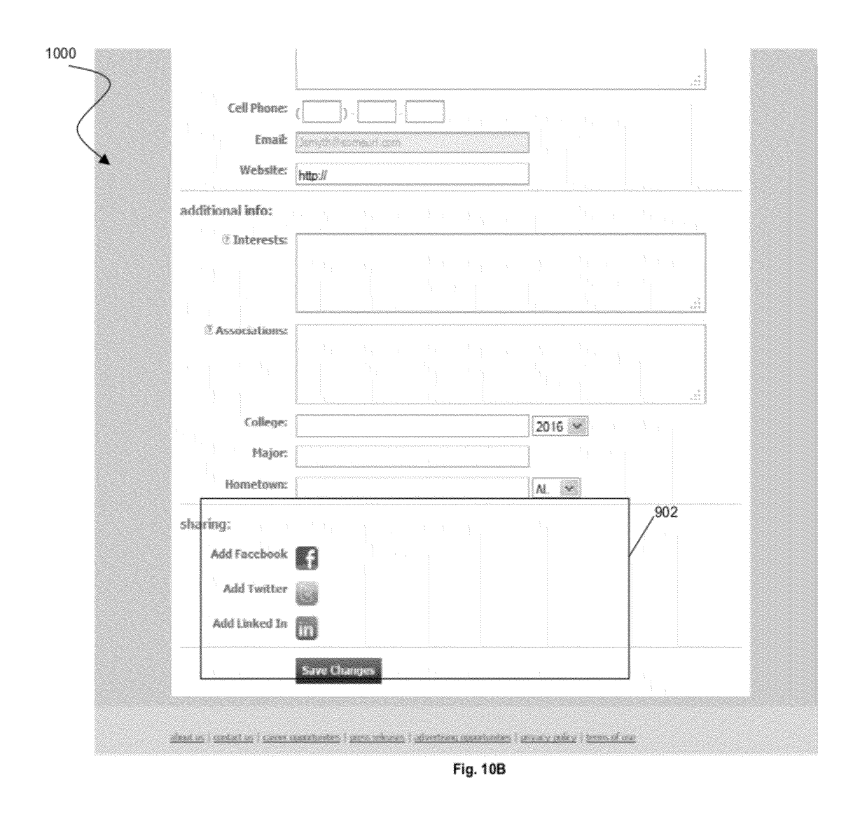

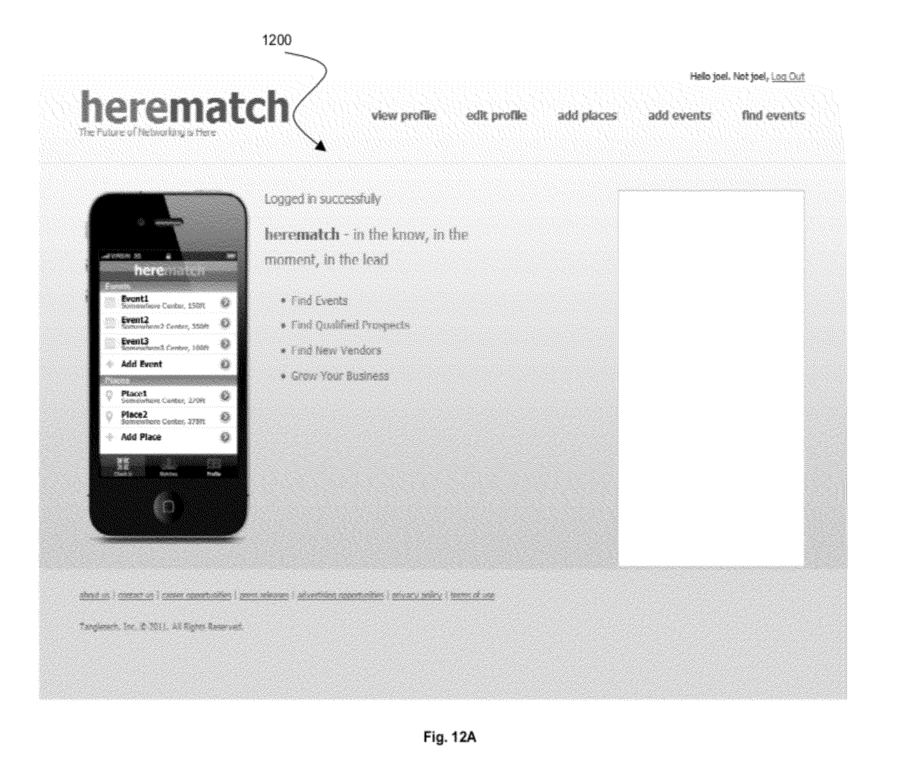

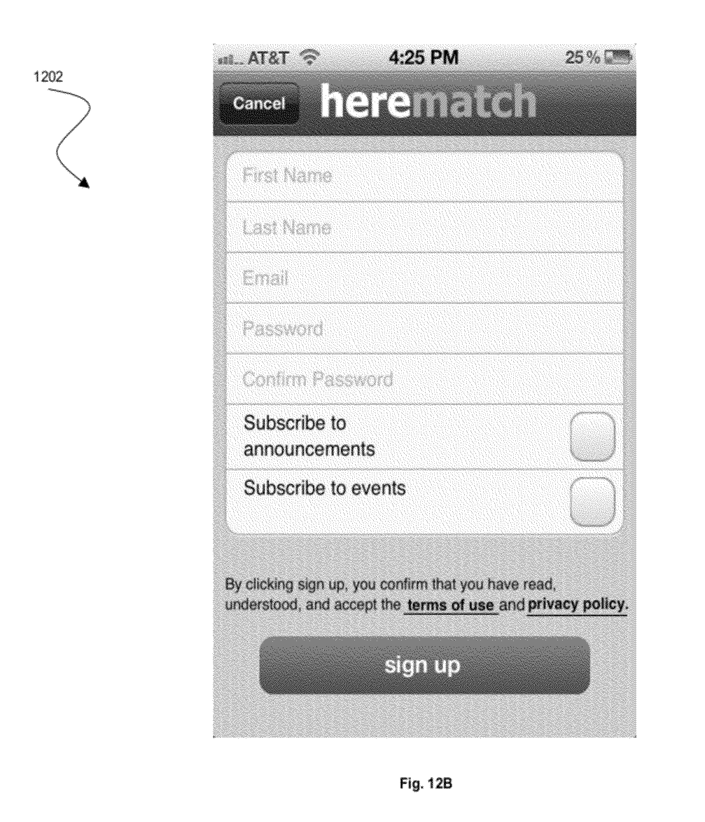

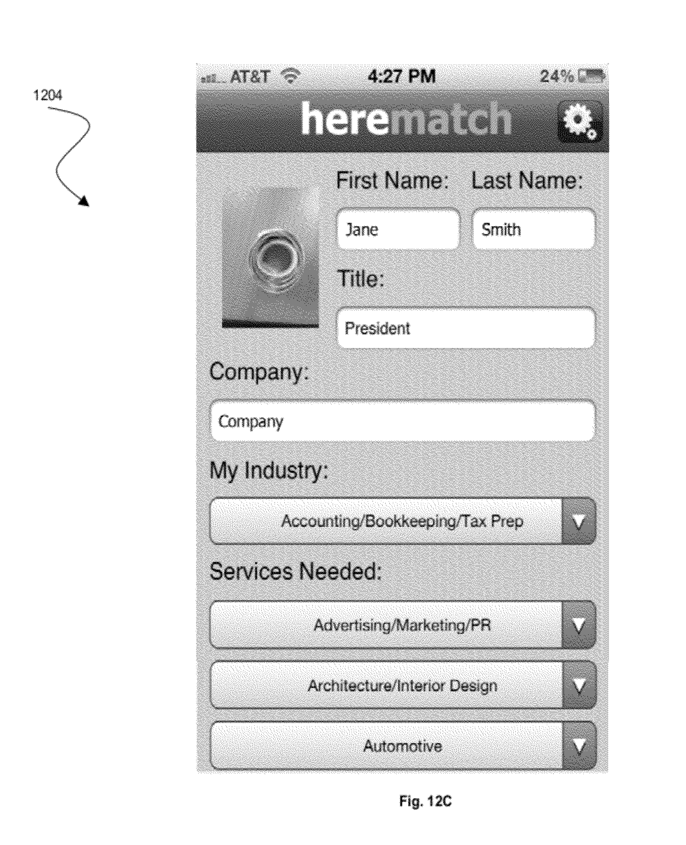

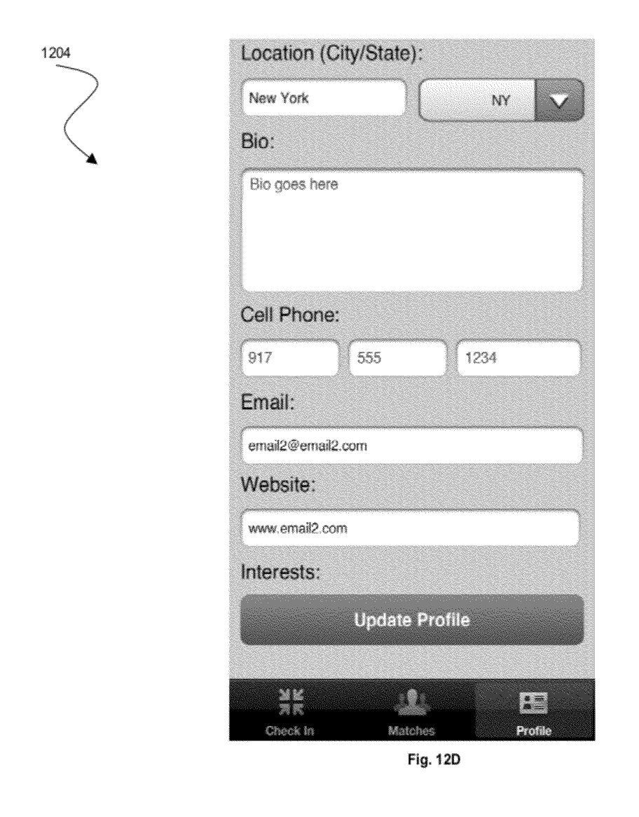

In one embodiment, users create a detailed profile. Examples include profile data entry display screen 1000 (FIGS. 10A and 10B), and display screen 1204 (FIGS. 12C and 12D). Upon check-in at a location and/or event, profile information is compared with other profiles to generate a match which can then be displayed on the users' mobile devices. Additionally, features may be provided that allow for advertising offers to be matched to profiles as well.

Thus and in an embodiment, a platform is provided that leverages detailed online profiles, a matching algorithm, and cellular, Wi-Fi, GPS, and other positioning technology-based check-in systems on mobile computing platforms (smartphones, tablets, laptops, or the like) to generate real-time connections with new people or products in the real world at a user's current location.

In an embodiment, the system uses global positioning system (“GPS”) technology, cell tower triangulation, local wi-fi network data, or other suitable positioning technology to monitor the location of a user carrying a mobile computing device 104 and, once a location is added in information processor 102, the user gets automatically check-in to the location. Moreover, information processor 102 matches various data, including the location, industry, stated needs, interests, memberships or the like, and indicates that one or more other users are appropriate matches for the user. Information representing why the respective matches are made may similarly be indicated.

In the event that the user wants to make contact, e.g., have a face-to-face meeting with one of the matched contacts, the user selects one or more options in the mobile computing device 104 and the potential contact is notified by information processor 102, such as via e-mail, SMS or other suitable communication channel. If the other user express an interest in meeting the user, then information processor provides sufficient information for the two contacts to meet, which may include images of the users or other contact information for the two users to meet.

Another embodiment is that profile information can be restricted from public view. In contrast with traditional social networking sites, the minimum information necessary to justify a match may be displayed to a user. Connections may be transferred to traditional social networks. However, our systems preferably do not include those features. Along these lines, the services provide among the strongest protections of personal data available. Unlike FACEBOOK, which generates greater value through greater and greater transparency and sharing, the present application generates value for the participants while maintaining and valuing user privacy.

One or more embodiments may be based on a unified platform, while providing several different sites/apps for distinct audiences. Three examples of such embodiments are described below.

In accordance with an embodiment, BusinessTap may focus on business networking. CollegeTap may focus on socializing in college. SocialTap may focus on socializing in the whole world. These are discussed below.

Business Intent:

Create a new form of mobile social networking.

Implement simultaneously as a business service and social tool using the same platform, but storing and matching different data.

Develop a user base before other players enter the market and harness the network effect to create (and monetize) a new advertising paradigm as a function of the user base.

Initial Revenues:

Advertising on the website and mobile device applications.

Paid premium apps and/or monthly subscription for (priority matching, or the like).

Additional Revenues:

Sell advertising at specific locations against user profiles. This can be done without ever exposing the user profile data to the advertisers.

Create brand specific apps that tie into existing registrations rather than the Mobile Match platform.

Sell anonymous aggregate demographic user data to advertisers to allow them to better understand their users (based on manually completed surveys and responses to advertising on the system—to inform other advertising decisions—advertiser may think customers are of a certain demographic, but based on the response to an advertisement, an advertiser can be informed of a customer's demographic as responses may be tied to profiles).

BusinessTap Audiences/Objectives: It is envisioned herein that there may include seven categories of audiences for the present application. These are described below:

Visitors: These are users who have not yet registered with information processor 102. Options are preferably provided for visitors to learn what the system is about and why it is relevant to them/worth signing up for.

Registered Users: These are users who have registered with information processor 102 and have access to the system. Registered users may be provided with options to easily meet potential customers and vendors as well as a way to find individuals with common interests and backgrounds while attending business networking events (conventions, conferences, tradeshows, business card exchanges, or the like).

Event Managers: These are users who are hosting events. They are provided options to add locations to the system and schedule events at these locations. They may also make announcements through the system to attendees (Registered Users).

Site Administrators: These are the users who manage site content. They update page content (text and images) and are provided with tools for updating any content that may require frequent changes. They also manage the user profile fields and values used in the matching criteria.

Advertisers: These are users who pay for advertising space on the web site and/or app. Advertisers receive reporting statistics and receive information regarding how campaigns are progressing. This group also has the ability to advertise to the appropriate attendees (Registered Users) based on respective user profiles.

System: While not a user in the same sense as the people who use features disclose herein, this “user” captures information that are preferably handled automatically such as sending match notifications to Registered Users check-in.

Premium Users: Additionally, support for premium (paid) memberships may be provided. This may take the form of members using a paid version of the app and/or members subscribing to a premium service on a monthly basis. Paid members may have access to priority matches.

CollegeTap Audiences/Objectives:

It is envisioned herein that there are six categories of audiences for the present application.

Visitors include individual, similar as described above with regard to BusinessTap.

Registered Users—Registered users are similar users as BusinessTap, but may be those who are focused on making social, not business connections. They may include incoming freshmen, and upperclassmen as well.

Site Administrators, Advertisers, Premium Users and System include users that may include rights and responsibilities described above with regard to BusinessTap.

SocialTap Audiences/Objectives: These include audience and objectives substantially as set forth above with regard to CollegeTap.

Visitors—These are as described above, with regard to Business/CollegeTap.

Registered Users—These registered users include users that may include rights and responsibilities described above with regard to CollegeTap except they may not be limited to college communities.

Site Administrators, Advertisers, System and Premium users include users having rights and responsibilities described above with regard to Business/CollegeTap.

BusinessTap User Information:

A website's mission is, typically, to allow users of the site to achieve specific tasks. In an embodiment, the way that audiences may complete tasks related to the features described herein may be documented. Capturing user information (referred to herein, generally as “stories”) are a convenient way to document notes about these tasks in a way that allows programmers to relate to them.

In an embodiment, user information is broken down by user group, such as described below.

As used herein, the term, “app,” refers generally to a client application that is installed on one or more mobile devices, including smartphones and portable devices. The term, “web,” refers to functionality that is provided via one or more Internet web sites and accessible using standard web browsing software. Some features may be provided via an app, some may be provided via the web, and some may be provided via both.

Visitors—Visitors may be able to view the freely accessible site content (including information about the service) to learn more about the site, and to decide whether or not to register, and are provided with tools to register.

View Free Pages (web)—Visitors may be able to navigate the site to view the freely available site content.

Initial Registration (web)—Visitors may be able to register (registering preferably includes creating a minimal profile that allow them to set their full profile at a later date). One goal of the registration screen is to make it quick and easy to register, in order to maximize conversion rates.

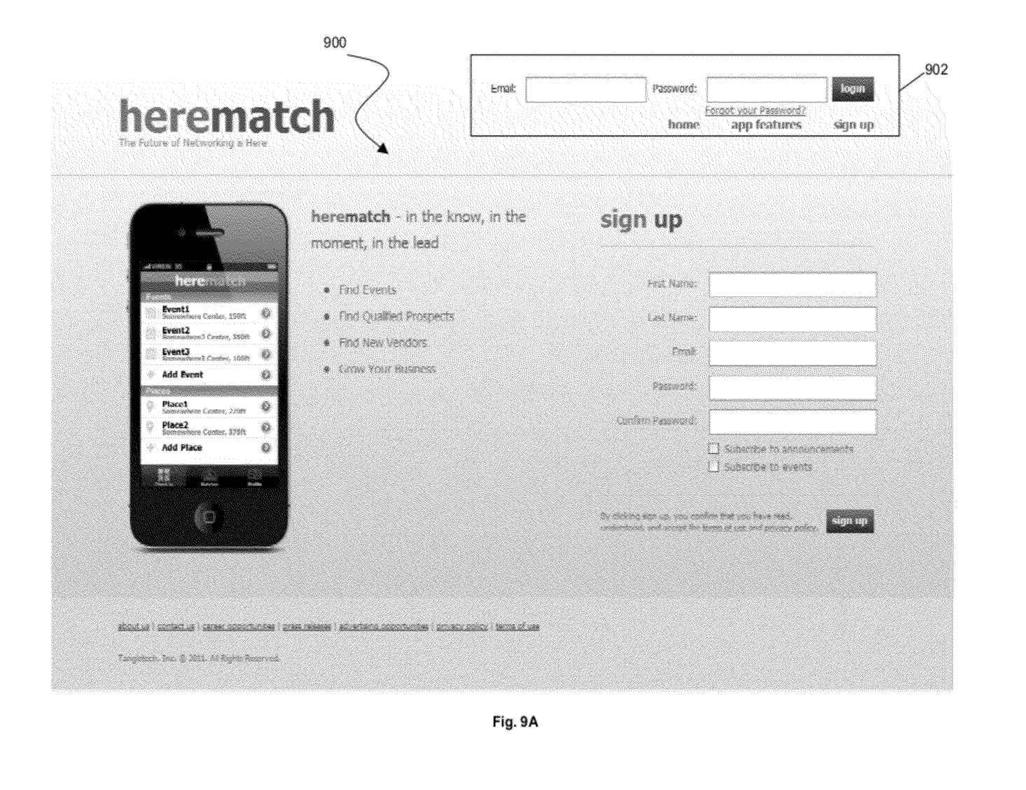

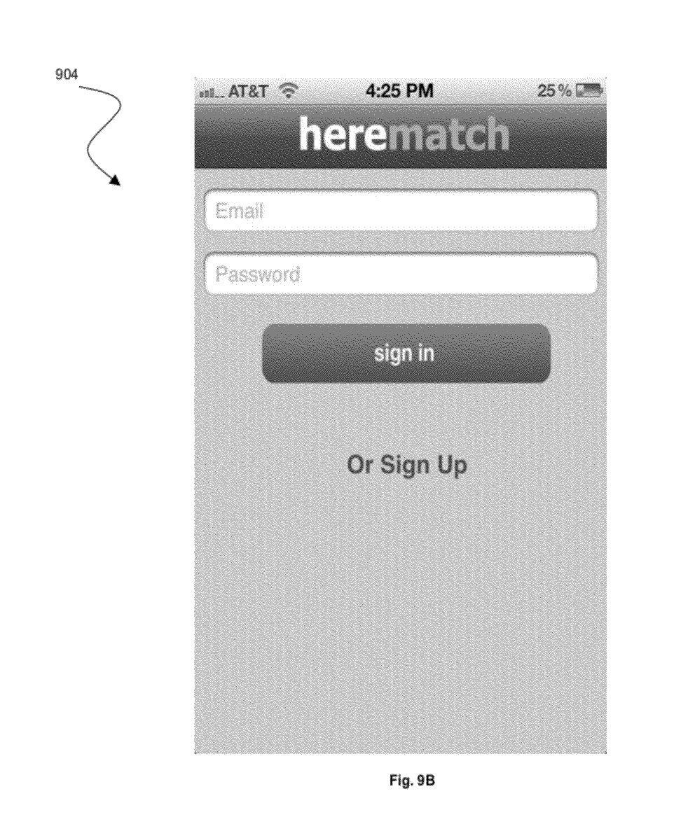

With reference to FIG. 9A, data entry display screen 900 may includes fields for a user's First Name, Last Name, Email Address, Confirmation of Email Address, Password, and Confirmation of Password. Moreover, one or more check boxes are provided to allow users to opt in to informational emails such as a monthly newsletter. If the user checks the box, they may be added to the mailing list. Once the form is completed, the data are validated to ensure the visitor entered at least a First Name and Last Name, that the appropriate confirmation fields match the values entered in the Email and Password fields, and that the Email appears to be a well-formed email address.

If the form is invalid, it may be redisplayed, pre-filled with any valid data the user entered, and displays clear error message(s) for the problem(s) encountered. All error messages may be displayed at the same time rather than just validating one field at a time, allowing the user to fix multiple errors in a single step.

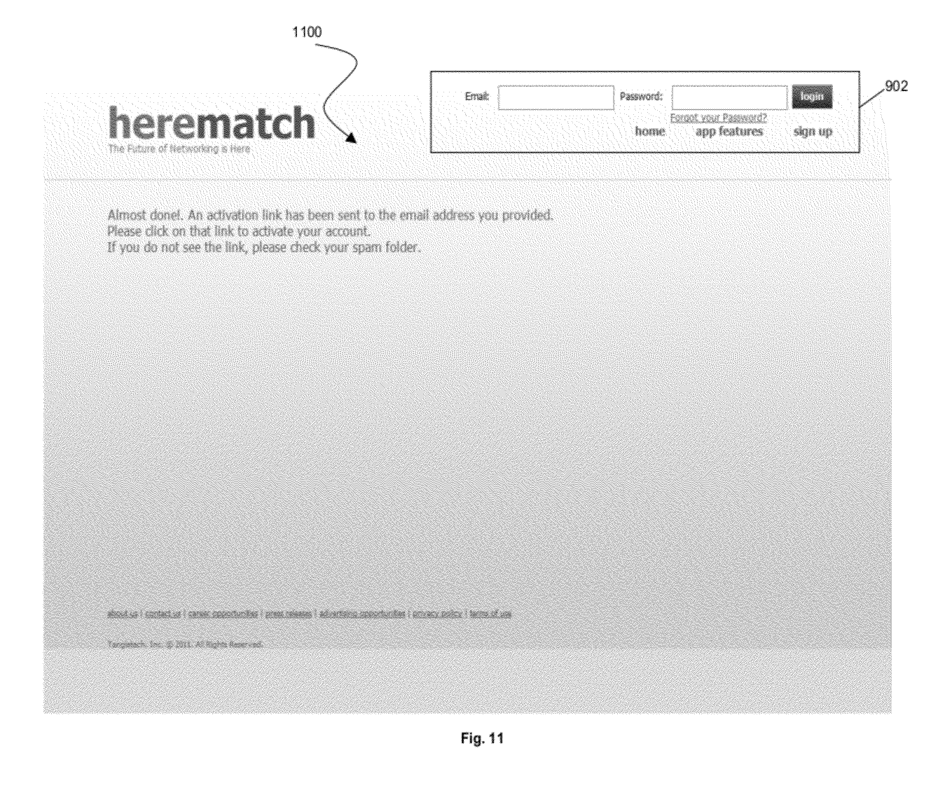

When the user successfully completes the form, an email may be sent to validate that the Email Address works and that they have access to it. See for example, FIG. 11. When the user clicks on the link in that email, the account may be validated, allowing the user to log in as a registered user. Clicking on the link may take them to a page that thanks them for registering and gives them a link to manage their profile. See the “Set Preferences” information below for Registered Users.

Initial Registration (app)—This may be substantially as described above, with regard to web-based information. FIG. 9B illustrates a log-in display screen 904 provided on mobile computing device 104 in accordance with an embodiment. FIG. 12B includes a display screen provided on mobile computing device 104 for initially registering with information processor 102, in accordance with an embodiment.

FIGS. 12C and 12D illustrate a combined view profile and edit profile display screen 1204 provided on mobile computing device 104 in accordance with an embodiment. The icon in the upper right corner (FIG. 12C) takes you to a user settings page (not shown). The data fields may be editable and may be saved by touching the button at the bottom of the page. The image provided may be an image of a user, such the user's photo. In an embodiment, the user's image may be taken on the phone, selected on the phone or uploaded using the web interface. Other information includes: name, company, industry information, and services desired (identified as needed in FIG. 12C) (e.g., provided via drop down lists). Other data are illustrated in FIG. 12D, and may include location, bio, telephone contact information, email and web site. Update profile button may also be provided to update the database.

Registered Users:

In addition to being able to do anything that a Visitor can do, a Registered User may be able to log in, retrieve a forgotten password, manage their profile, check in, view matches, and send messages.

Log in (web)—Registered Users can log in by entering their Email Address and Password, for example, in Log In Section 902 (FIGS. 9, 11). If the Email and/or Password is invalid, the login screen may be re-displayed with a message informing them that the credentials are invalid. If the login is valid but they have not yet confirmed their Email Address a message may display stating that their account has not yet been validated. Users may also be informed to click the link in the email, and display a link that can be used to send a new activation email.

If the credentials are valid and they have confirmed their Email Address, the system may redisplay the site with a “Welcome First Name Last Name” message with links to “Set Preferences” and “Logout,” and may keep them logged in until their session expires (about 20 minutes of inactivity). See for example, FIG. 10A. If the user tries to access a page requiring them to be logged in after the session expires, they may be returned to the login screen. When the user is directed to a login screen from another page on the site, that page may be “remembered”, so that upon completion of the login task they are returned to the “remembered” page.

Alternatively, users can log in using, for example, an OAuth 2.0 based log in systems offered by one or more current social networks (FACEBOOK CONNECT, for example).

In an embodiment, one or more prioritizations is provided, including relating to data and/or social network web sites.

Log in (app)—Similar to the web-based information including integration with OAuth 2.0 based log in systems. However they also may include an option to save log-in credentials for future use rather than requiring credentials to be re-entered. In an embodiment, there are not any session expirations. The app may be open or closed with the user logged in or not.

Retrieve Forgotten Password (web)—In an embodiment, if a registered user has forgotten a password, the user enters an Email Address, and, if the Email Address is in the system, a hyperlink may be sent by email to enable the user to reset the Password. Clicking on that link takes the user to page to enter a password and confirm the Password. If the passwords match, the password may be updated. If not, the form may be redisplayed with an error message advising them that the passwords did not match. The link in the email may expire after two days or after a successful use of the link to change the password. If a Registered User clicks on an expired link, the site displays a message telling them that the link has expired and asking them to enter their email address to have new valid link sent to them.

Retrieve Forgotten Password (app)—This may be substantially as described above, with regard to web-based information.

Manage Profile (web)—This feature allows a Registered User to set profile and matching preferences. The profile may include fields, for example, for: Photo, Company, Title, Industry, Products/Services Offered, Description of Products/Services, Cost of Products/Services Specialties, Target Industry, Target Project Size, Products/Services Needed, Budget Per Product/Service Needed, Affiliations, Location, Geographic Area served. Affiliations may include things like High School attended, College Attended, Fraternity, Fraternal Order, Networking Group, or the like. In addition, for each field, the user can mark items as public or private which may impact what matched users can see when a match is made.

The matching preferences may include: Priority (with options of Client, Vendor, or Networking).

When a user brings up this page, previously entered information may appear and the fields may be editable. As new criteria are created by the admin, they may be noted at the top of the screen and/or highlighted on the page so that users can refine their profile/matching as the system grows. This page may use advanced AJAX style forms—for example as a user adds the Products/Services Needed, a field for the Budget for the given Product/Service can be filled out, but when submitted fields for another pair may display without the need to reload the page.

Moreover, users may be able to suggest a profile field/options to be included in the Profile Manager.

Manage Profile (app)—This may be substantially as described above, with regard to web-based information.

Find Events (web)—Users may be able to see a list of events that match their profiles. Clicking on an Event Title/Logo may bring up detail on the Event as well as a link to the Event site and Event registration page.

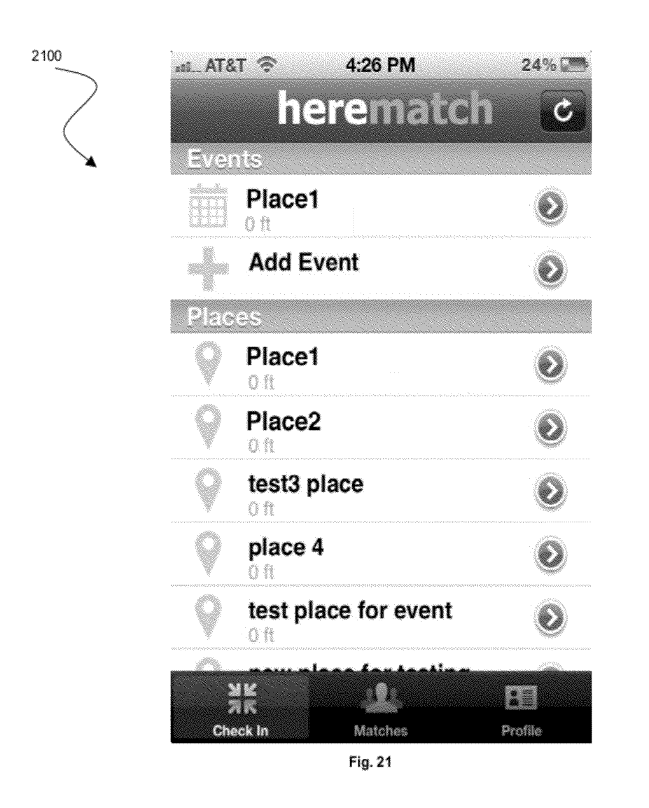

Find Events (app)—This may be substantially as described above, with regard to web-based information. In addition, a list of currently occurring events near the user's location may be displayed as illustrated in FIG. 21.

Check-In (app)—Check-In may be by location and event. Regardless, a user may be able to check into a location and upon check in, if there is more than one event, select an event to check into, for example, in connection with multiple concurrent events at a convention center. Based on the user's settings, the check in may or may not be published to social feeds. A check in may display a list of locations nearby based on the location coordinates provided by the mobile device. The user may select the appropriate location from the list or search for other nearby locations using a search field. The user may click on the appropriate location to see additional details and check in. As part of checking in, a user may also be able to report a closed or duplicate location and create a new location.

Auto Check In Preferences (web)—As an alternative to manually checking in to a location or event, a user may set auto check in preferences in advance. These auto check in preferences may include selecting specific locations or events for auto check in, or selecting more general attributes that describe locations and/or events that are the kind of locations and/or events the user would like to auto check in at. In addition, the user may request automatic auto check in or simply notification when the user is near a location or event that meets the user's auto check in preferences prompting manual check in.

Auto Check In Preferences (app)—This may be substantially as described above, with regard to web-based information.

Auto Check In (app)—The user may auto check-in when they reach a designated radius from a location or event that fits their auto check in preferences as described above. Or, they may receive a notification as indicated above. If they are auto checked in, then match criteria would immediately run as if they manually checked in.

Enable Prefetch Matches (web)—In addition to manually checking in and auto checking in based on auto check in preferences, a user may also enable prefetch of matches. In this mode, the user may be notified of nearby locations and events where, based on their profile and the profiles of the checked in users, and provided they are checked in, a match may be made. Users can determine what criteria may count as a prefetch match. This criteria may be different from their normal match criteria.

Enable Pre-fetch Matches (app)—This may be substantially as described above, with regard to web-based information.

Pre-fetch Matches (app)—When enabled (as described above), a user's mobile app periodically polls locations and events near the user's location for possible matches. In case of a match, the user may be notified of the nearby location or event and give them an opportunity to check in. The details of the match itself may or may not be visible prior to actual check in.

View Matches (app)—Upon check in, the system may run its matching criteria for the checked in user against all other checked in users at the same location or event. Relevant matches may display on both users' apps in order of closest matches (based on both users' profiles and matching criteria). The list of matches may show the user's photo as well as the name, company name, and most relevant matching detail. Registered users may be able to view each of the matches including details of the match and the matching user's profile. Users may be able to toggle on or off Known matches (people the user already knows in real life).

View Matches (web)—Matches may not only be presented immediately, but may also be available for review on the web site. This is for when two users are unable to meet at the location (too big, too crowded, or the like). However, in this embodiment, features set forth in a more traditional social networking site may be supported or provided.

Rerun Matches (web)—Matches may not only be available for review on the web site when two users are unable to meet at the location, but users may also rerun matches at events they attend. This allows users to generate matches against people who attended the same event as them in real time, but at different times. For example, user 1 attends an all day convention from 9:00 AM to 11:00 AM. User 2 attends the same all day convention, but arrives at noon and leaves at 3:00 PM. The users were at the same event, but not at the same or overlapping times. As such, neither user matched the other. However, these users may have matched if they had been at the event at the same time. By allowing users to rerun matches at events they checked in at any time, presents the match to the users.

Suggest Locations And Events (web)—In addition to using detailed profiles to match users to users, locations and events may also be suggested for users to frequent. These suggestions may be based on both the user's own profile as well as the profiles of users who check in at various locations and events. For example, a user runs the search on the web site. The matching algorithm runs and considers various locations and events. The match may run against the aggregate historical check ins at the locations and events in the system instead of the current check ins. Locations and events where a minimum threshold of matches would have taken place in a historical time period may be displayed.

Suggest Matches (web)—Another matching feature provided in accordance with an embodiment enables users to run matches on the web site against all users in accordance with one more filtering criteria, e.g., certain industries and/or geographic area. The matching algorithm may use the same elements as used during real-time matching. However it would also include the number of times users checked in to the same locations or events as the user running the match. Information collected as a function of a user visiting a location or event may be as revealing as information submitted by the user in a user profile. Moreover, if two users match by frequenting the same location at the same time of day, but different days, introducing them to each other on the web correlates to introducing them in real time. Optionally the criteria could be type of location or event instead of specific event or location. Only matches based on one or more filtering criteria that also meet a minimum threshold of matching check-ins may display results.

Send/Receive Messages (app)—When viewing each match, a button may be provided to send a message to the other party. Moreover, default messages like Accept and Reject may be provided, and a Know Already checkbox, as well as a freeform text field that can be used to set up a face to face meeting and respond to messages (for example, “Meet me in front of booth 510 to discuss our project needs.”) may be provided. These messages may appear on both user apps similar to SMS messaging or IM chat systems and be mediated by the server. On supported phones, a link to location a call or load FACETIME (or a similar tool) may appear. In addition, either on this screen or as part of a user's preferences, each user can choose to share matches. If both users set Share Match to yes, the system preferably publishes the match to their social feeds. Further, both users may have the ability to initiate a connection/friend request from this screen.

Send/Receive Messages (web)—This may be substantially as described above, with regard to the app information. This is preferably implemented when the View Matches (web) information is implemented.

Check-Out (app)—Check Out may be defined by location and event. The user releases their Check-In so that they are no longer matched to other users and no longer receive matches based on other user profiles at the location and event. In addition to manually checking out, users may be auto checked out after a predetermined period of time. This may be system-wide, location or event specific, or user defined. In addition, users may opt to be auto checked out when they move a specific distance from a location or event.

Event Managers:

The Event Managers may add locations and events to the system. In an alternative embodiment, any registered user may add locations and events.

Add Location (web)—Event Managers may be able to add locations such as convention halls, conference rooms, auditoriums, or the like.

Add Location (app)—This may be substantially as described above, with regard to web-based information.

Add/Edit Event (web)—Regardless of the check-in system used, in BusinessTap there may be a second level beyond just location called Event. The Event may be assigned to a Location or Locations. It may include fields for: Event Name, Event Category, Event Start Date, Event Start Time, Event End Date, Event End Time, Event Description, Event URL, Event Registration URL.

Add/Edit Event (app)—This may be substantially as described above, with regard to web-based information.

Generate Widget (web)—Event Managers may have the option to generate a widget that displays the number of check-ins and matches at a respective location or event. This widget may display on an event manager's web site, and update substantially in real-time with data obtained from information processor 102. This is useful, for example, to Event Managers, as a way to advertise traffic at their location or event, as well as the connections being made. Statistics may be displayed for individual locations and/or events. Statistics may also be displayed in aggregate for all events produced by the Event Manager.

Claim Place/Event (web)—Event Managers may have the ability to claim a location or event. One or more options may be provided for Event Managers to authenticate themselves as the owner or otherwise responsible party associated with the location or event, and then modify said location or event.

Check In Notification (web)—Event Managers may also have the ability to be notified when users check in to their location or event. This notification may be through the mobile app, by text, email, or in a report accessible online. Methods and instructions are further supported for exporting this data into event management software.

Send Announcements (web)—Event Managers may have the ability to send announcements to users checked in at their location or event. These announcements may be sent within the mobile app, by text, email, or other method. They may be scheduled in advance to announce the beginning of seminars, or the like, or they may be generated at will by the Event Manager.

Site Administrators:

The Site Administrators may be able to manage the static pages on the site and manage advertisers.

Manage Static Pages (web)—The Site Administrators may be able to log in and use a “page manager” to manage the content on pages using a WYSIWYG (What You See Is What You Get) editor.

Manage Advertisers (web)—Site Administrators may be able to load ads into the system. The simplest initial implementation is for the Site Administrator may add an “advertiser” which may have an Email Address, Password, Company Name, and all of the details of the Advertiser's Ad. The advertiser may then be able to log onto a special advertiser's page to see reporting on their Ad (see the view reports information in the Advertisers section below for more details).

Each Ad may have a Name, an Image, and a Target URL (where click-throughs should go). Each one can be associated to one of various positions (e.g., topbar, sidebar) and associated to one or more pages. Ads may also have the following options: Start Date, End Date, Maximum Views, and Maximum Click-throughs. A user can use any combination, so for a site sponsorship a user sets Start and End Dates. For a pure CPM (cost per thousand views) a user sets Maximum Views and for a pure CPC (cost per click) a user sets Maximum Click-throughs.

The Site Administrator can list, add, view (reporting information), edit, and delete Ads. Once created, the Start Date, End Date, Maximum Views, and Maximum Click-throughs are preferably not changed to avoid potential problems. For example, setting Maximum Views to 100 after an Ad has already been viewed 300 times, the system would appear to be broken or otherwise not functioning correctly.

Send Email Blast (web)—The Site Administrators may be able to send emails out to anyone who has signed up for information about the site. To maximize deliverability of the emails the site may integrate with a third party email marketing system. As part of the integration, when a user registers on the site, they can also subscribe to the newsletter seamlessly. The third party email marketing system may allow for private labeling so that no third party brand appears on the emails.

Generate Site Statistics (web)—Site Administrators may generate detailed statistical reports on anonymous aggregate data. In an embodiment, these reports are filterable by day of the week, date range, time range, time of day, and totals, and may further be available in mean, median, and mode. The data may be filterable by creator. Reports may include a number of events (both by when the event was added and when it occurred) and the events can be filterable by category, industry, and associated location. Reports may further include locations filterable by category, the number of check ins and the number of matches by location, event, total events at a location (with and without the location itself), and in aggregate. Matches may be further filterable by the reason for the match (general category of match as well as the specific matching criteria). These include reports on the number of users filterable by all user profile fields as well as by number of check ins and number of matches.

Manage Users (web)—Site Administrators may view a list of users, filter the list, and search the list by user profile fields. They may select individual users to disable and/or delete their accounts to remove accounts that violate the terms of use.

Manage Locations (web)—Site Administrators may view a list of locations, filter the list, and search the list by location fields. They may select individual locations to disable, delete, edit, and/or merge with other locations. Disable and delete may be used to remove offensive or non-existent locations. Edit may be used to correct incorrect data. Merge may be used to combine two or more distinct locations that actually represent the same entity.

Manage Events (web)—Site Administrators may view a list of events, filter the list, and search the list by event fields. They may select individual events to disable, delete, edit, and/or merge with other events. Disable and delete may be used to remove offensive or non-existent events. Edit may be used to correct incorrect data. Merge may be used to combine two or more distinct events that actually represent the same entity.

Advertisers:

Advertisers may be able to log in to see reporting information relating to their Advertisements.

Advertiser Login/View Reports—An Advertiser may be given a special URL to go to. There they may be able to log in using their Email and a Password provided by the Site Administrator manually. When they do so, they may see a simple report on their Ad with its Name, the Image, information about where it is being displayed, the Start Date, End Date, Total Views, and Total Click-throughs to date.

System:

The system is responsible for running matches and sending notifications. It is also responsible for the ad system—specifically displaying ads, tracking ad views, and notifying when an ad expires.

Display Locations and Store Check-Ins—The system displays locations based on submitted location coordinates and stores check-ins including the number of check-ins at a location and the demographics of the users checking in.

Release Check-Ins on Check-Out—The system releases Check-Ins based on user input and possibly after a set period of time (may be system, may be user determined setting). Once released, they are no longer matched against other profiles.

Running Matches—When a Registered User checks in, the system may run a proprietary algorithm to generate matches against other checked in users. This algorithm may include a comparison of profiles, a comparison of prior matches confirmed, and events participated in (or category of event participated in). Results may also be refined by the users' matching priorities. Possibly, the use of 3rd party APIs such as FACEBOOK's Social Graph API are usable to mine additional relevant data for matches.

Notifying Matches—Checked-In users may receive match notifications listed in priority order through the appropriate platform (IOS, ANDROID, BLACKBERRY, WINDOWS PHONE 7, or the like) notification mechanism.

Send Communications—The system may distribute messages within the app between users.

Publish To Social Feeds—When appropriate, the system may use the relevant APIs to publish to various social media feeds.

Display Ads—Whenever a user requests a page, or when an email is sent out, the system may display appropriate ads based on advertiser criteria and user profiles.

Track Ad Views—Whenever a user clicks on an Ad the system may track what Ad, what page/email, which user and what date/time the click was made. It may then redirect the user to the target URL for that Ad.

Email on Ad Expiration—Whenever an Ad expires (endDate=today or just hit max views or CPC's) it may be set to expired so it is not shown again. At the same time, an email may be sent to both the Advertiser and the Site Administrator to notify them that the Ad has expired. This email may include a link to view the reporting information.

Premium Users:

A number of different options may further be provided for Premium Users. For example, “Priority Matching” and “Web Matching” are included for premium users.

Priority Matching—Premium Users, e.g., users who purchased a premium (as opposed to free) mobile app or users who subscribe to a premium services (which may require premium registration information). Either way, if enabled, Premium Users may see matches before Registered Users, such as to provide a time period (e.g., 5 minute) head start, or may be listed at the top of the matches even if the match relevance is lower.

Web Matching—Premium Users may run matches on the web site as well as on their mobile phone. These matches may return relevant matches based on a similar but slightly revised algorithm that takes into account what types of locations the user checks in at regardless of whether users are at that location at the identical time.

CollegeTap User Information:

These may be substantially as described above with regard to BusinessTap.

Visitors—These may be substantially as described above, with regard to BusinessTap.

View Free Pages (web)—These may be substantially as described above with regard to BusinessTap.

Initial Registration (web)—This may be substantially as described above with regard to BusinessTap. However, in at least one embodiment this may be limited to .edu email addresses. In at least one embodiment it may be limited to specific .edu email addresses. And, in at least one embodiment, it may be open to the public.

Initial Registration (app)—This may be substantially as described above with regard to BusinessTap.

Registered Users: This may be substantially as described above with regard to as BusinessTap.

Log in (web)—This may be substantially as described above with regard to BusinessTap. However, if OAuth 2.0 integration is used, FACEBOOK would be prioritized over LINKEDIN by default, for example.

Log in (app)—This may be substantially as described above with regard to BusinessTap.

Retrieve Forgotten Password (app)—This may be substantially as described above with regard to BusinessTap.

Manage Profile (web)—This may allow a Registered User to set profile and matching preferences. The profile may include fields for: Photo, Gender, Age, School, Year, Major, Minor, Dorm, Hometown, Religion, Politics, Interests, Activities, Affiliations, Relationship Status, Sexual Orientation, and Interested In (relationship, friendship, networking). Optionally, users may select classes they are taking or have taken in the past. In addition, for each field, the user can mark items as public or private which may impact what matched users can see when a match is made.

The matching preferences may include priority (with options of relationship, friendship, and/or networking). Additional matching preferences may include: town/gown and my school/any school. Furthermore, users may be offered an option to weight various matching criteria. For example, politics may be more important than activities.

When a user brings up this page, previously entered information may appear and the fields may be editable. As new criteria are created by the admin, they are preferably noted at the top of the screen and/or highlighted on the page so that users can refine their profile/matching as the system grows. This page may use advanced AJAX style forms.

Manage Profile (app)—This may be substantially as described above with regard to web-based information.

Check-In (app)—This may be substantially as described above with regard to BusinessTap except the check-in may be by location only, not event.

Auto Check In Preferences (web)—This may be substantially as described above with regard to BusinessTap except the check-in may be by location only, not event.

Auto Check In Preferences (app)—This may be substantially as described above, with regard to web-based information.

Auto Check In (app)—This may be substantially as described above with regard to BusinessTap except the check-in may be by location only, not event.

Enable Prefetch Matches (web)—This may be substantially as described above with regard to BusinessTap except the check-in may be by location only, not event.

Enable Pre-fetch Matches (app)—This may be substantially as described above, with regard to web-based information.

Pre-fetch Matches (app)—This may be substantially as described above with regard to BusinessTap except the check-in may be by location only, not event.

View Matches (app)—This may be substantially as described above with regard to BusinessTap except the fields displayed may differ as appropriate.

View Matches (web)—This may be substantially as described above with regard to BusinessTap.

Rerun Matches (web)—This may be substantially as described above with regard to BusinessTap except the check-in may involve locations, not events.

Suggest Locations (web)—This may be substantially as described above with regard to BusinessTap except the suggestions may be by location only, not event.

Suggest Matches (web)—This may be substantially as described above with regard to BusinessTap except the suggestions may be by location only, not event.

Send/Receive Messages (app)—This may be substantially as described above with regard to BusinessTap.

Send/Receive Messages (web)—This may be substantially as described above with regard to BusinessTap.

Check-Out (app)—This may be substantially described above with regard to BusinessTap, except the check in may be defined by location, by event or by both.

Site Administrators: This may be substantially as described above with regard to BusinessTap.

Manage Static Pages (web)—This may be substantially as described above with regard to BusinessTap.

Manage Advertisers (web)—This may be substantially as described above with regard to BusinessTap.

Send Email Blast (web)—This may be substantially as described above with regard to BusinessTap.

Generate Site Statistics (web)—This may be substantially as described above with regard to BusinessTap except the data may be by location only, not event.

Manage Users (web)—This may be substantially as described above with regard to BusinessTap.

Manage Locations (web)—This may be substantially as described above with regard to BusinessTap.

Turn On College (web)—In an embodiment, a sort of “throttle” may be provided to manage user base growth, which operates as follows: instead of users registering and immediately being able to log in, the site keeps these “preregistrations” on hold until a certain number of users have at the college have preregistered. Once the minimum is hit, the admin would then turn on the college.

Advertisers:

Advertiser Login/View Reports—This may be substantially as described above with regard to BusinessTap.

System:

This may be substantially as described above with regard to BusinessTap.

Display Locations and Store Check Ins—This may be substantially as described above with regard to BusinessTap.

Release Check Ins on Check Out—This may be substantially as described above with regard to BusinessTap.

Running Matches—This may be substantially as described above with regard to BusinessTap.

Notifying Matches—This may be substantially as described above with regard to BusinessTap.

Send Communications—This may be substantially as described above with regard to BusinessTap.

Publish To Social Feeds—This may be substantially as described above with regard to BusinessTap.

Display Ads—This may be substantially as described above with regard to BusinessTap.

Track Ad Views—This may be substantially as described above with regard to BusinessTap.

Email on Ad Expiration—This may be substantially as described above with regard to BusinessTap.

Premium Users:

Priority Matching—This may be substantially as described above with regard to BusinessTap.

Web Matching—This may be substantially as described above with regard to BusinessTap.

SocialTap User Information:

This may be substantially as described above with regard to as Business/CollegeTap.

Visitors—These may be substantially as described above with regard to as described above with regard to Business/CollegeTap.

View Free Pages (web)—These may be substantially as described above with regard to Business/CollegeTap.

Initial Registration (web)—This may be substantially as described above with regard to BusinessTap. (Differs from potential restrictions on CollegeTap.)

Initial Registration (app)—This may be substantially as described above with regard to Business/CollegeTap.

Registered Users—This may be substantially as described above with regard to Business/CollegeTap.

Log in (web)—This may be substantially as described above with regard to CollegeTap.

Log in (app)—This may be substantially as described above with regard to CollegeTap.

Retrieve Forgotten Password (web)—This may be substantially as described above with regard to Business/CollegeTap.

Retrieve Forgotten Password (app)—This may be substantially as described above with regard to Business/CollegeTap.

Manage Profile (web)—This allows a Registered User to set their profile and matching preferences. The profile may include fields for: Photo, Gender, Age, College, Year, Degree, Graduate School, Year, Degree, Major, Minor, Dorm, Hometown, Religion, Politics, Interests, Activities, Affiliations, Relationship Status, Sexual Orientation, and Interested In (relationship, friendship, networking). In addition, for each field, the user can mark items as public or private which may impact what matched users can see when a match is made.

The matching preferences may include: Priority (with options of Relationship, Friendship, or Networking). Furthermore, users may be offered an option to weight various matching criteria—Politics more important than Activities for example.

In an embodiment, when the user brings up this page, previously entered information may appear and the fields may be editable. As new criteria are created by the admin, they may be noted at the top of the screen and/or highlighted on the page so that users can refine their profile/matching as the system grows. This page may use advanced AJAX style forms.

Moreover, a profile built in CollegeTap may be pulled into SocialTap.

Manage Profile (app)—This may be substantially as described above with regard to web-based information.

Check-In (app)—This may be substantially as described above with regard to CollegeTap—unlike BusinessTap, in an embodiment events may not play a part.

Auto Check In Preferences (web)—This may be substantially as described above with regard to CollegeTap—unlike BusinessTap, in an embodiment events may not play a part.

Auto Check In Preferences (app)—Substantially as described above, with regard to web-based information.

Auto Check In (app)—This may be substantially as described above with regard to CollegeTap—unlike BusinessTap, in an embodiment events may not play a part.

Enable Prefetch Matches (web)—This may be substantially as described above with regard to CollegeTap—unlike BusinessTap, in an embodiment events may not play a part.

Enable Pre-fetch Matches (app)—This may be substantially as described above, with regard to web-based information.

Pre-fetch Matches (app)—This may be substantially as described above with regard to CollegeTap—unlike BusinessTap, in an embodiment events may not play a part.

View Matches (app)—This may be substantially as described above with regard to Business/CollegeTap except the fields displayed may differ as appropriate.

View Matches (web)—This may be substantially as described above with regard to Business/CollegeTap.

Rerun Matches (web)—This may be substantially as described above with regard to CollegeTap—unlike BusinessTap, in an embodiment events may not play a part.

Suggest Locations (web)—This may be substantially as described above with regard to CollegeTap—unlike BusinessTap, in an embodiment events may not play a part.

Suggest Matches (web)—This may be substantially as described above with regard to CollegeTap—unlike BusinessTap, in an embodiment events may not play a part.

Send/Receive Messages (app)—This may be substantially as described above with regard to Business/CollegeTap.

Send/Receive Messages (web)—This may be substantially as described above with regard to BusinessTap/CollegeTap.

Check-Out (app)—This may be substantially as described above with regard to CollegeTap—unlike BusinessTap, in an embodiment events may not play a part.

Site Administrators:

These users may be substantially as described above with regard to Business/CollegeTap.

Manage Static Pages (web)—This may be substantially as described above with regard to Business/CollegeTap.

Manage Advertisers (web)—These may be substantially as described above with regard to Business/CollegeTap.

Send Email Blast—This may be substantially as described above with regard to Business/CollegeTap.

Generate Site Statistics (web)—This may be substantially as described above with regard to CollegeTap—unlike BusinessTap, in an embodiment events may not play a part.

Manage Users (web)—This may be substantially as described above with regard to BusinessTap/CollegeTap.

Manage Locations (web)—This may be substantially as described above with regard to BusinessTap/CollegeTap.

Advertisers: These may be substantially as described above with regard to Business/CollegeTap.

Advertiser Login/View Reports—This may be substantially as described above with regard to Business/CollegeTap.

System:

This may be substantially as described above with regard to Business/CollegeTap.

Display Locations and Store Check-Ins—This may be substantially as described above with regard to BusinessTap.

Release Check-Ins on Check Out—This may be substantially as described above with regard to Business/CollegeTap.

Running Matches—This may be substantially as described above with regard to Business/CollegeTap.

Notifying Matches—This may be substantially as described above with regard to Business/CollegeTap.

Send Communications—This may be substantially as described above with regard to Business/CollegeTap.

Publish To Social Feeds—This may be substantially as described above with regard to BusinessTap.

Display Ads—This may be substantially as described above with regard to Business/CollegeTap.

Track Ad Views—This may be substantially as described above with regard to Business/CollegeTap.

Email on Ad Expiration—This may be substantially as described above with regard to Business/CollegeTap.

Premium Users:

These may be substantially as described above with regard to Business/CollegeTap.

Priority Matching—This may be substantially as described above with regard to Business/CollegeTap.

Web Matching—This may be substantially as described above with regard to Business/CollegeTap.

Product Match Features:

As mentioned in the Business Intent section above, once the user base and the method of using mobile devices and profiles to expand a user's real world network has been established the new advertising paradigm can be monetized. This may take the form of matching product offers, recommendations, and discounts at locations against private user profiles. A feature of this may be that users may not have to expose their preferences to the retailers.

Registered Users:

Manage Shopping Profile (web)—In one embodiment, a Shopping Profile tab may be enabled on SocialTap/CollegeTap/BusinessTap. This may allow users to select the categories of items they would like to receive notifications on, the companies they would like to receive notifications on, and within each category the type of notifications (sales, coupons, recommendations) and their interests—this may include types of products, manufacturers, or the like, and may vary by category and or company. For example, if a retail clothing brand is a registered advertiser, a page may be provided to select Men's or Women's, as well as checkboxes for dresses, skirts, suites, pants, jewelry, or the like.

View Offers (app)—Just as with the Person-To-Person matches, offers may be displayed onscreen once a user checks in at a location. Users scroll through a list of offers and rate the relevance. Users display the offer on the screen of their mobile device to receive the discount (if one applies).

Advertisers:

Generate Offers (web)—Advertisers may be able to set offers against criteria that mirror the criteria a user can manage in their Shopping Profile. These offers can be sales, discounts, and/or recommendations or announcements of new products. These offers can also be targeted against user demographic data provided as part of user's basic profile. While ads can be targeted against this data, the advertisers may not see this data. For example, a clothing retailer may target different offers based on the sex of the user even if this is just set in the User Profile, not the Shopping Profile.

View Reports (web)—Advertisers can view statistics on the number of matches displayed and the rating for each offer. They can also run reports on aggregate anonymous demographic data of users who responded to their offers.

System:

Running Product Matches—Just as with Person-To-Person matches, when a Registered User checks in, the System may run a proprietary algorithm to generate matches. However, now the matches may be generated against product offers, not other checked in users.

Notifying Product Matches—Checked In users may receive match notifications listed in priority order through the appropriate platform (IOS, ANDROID, BLACKBERRY, WINDOWS PHONE 7, or the like) notification mechanism.

Branded Club Match Features:

In one embodiment this may take the form of matching product offers, recommendations, and discounts at locations against private user profiles. An advantage of this may be that users may not have to expose their preferences to the retailers. These profiles may be tied to the Mobile Match family of products as discussed in the previous section. Or, they may be profiles maintained through branded clubs. For example, a national retail clothing brand may use the Mobile Match platform to generate offers as described above, but send them out not only to Mobile Match users, but to their own members through a store branded app.

Advertisers:

These are variations on the corresponding information described for Advertisers above under Product Match Features in that the data is no longer in the Mobile Match secure environment (“walled garden”), thereby giving advertisers more information and users less control.

Generate Offers (web)—Advertisers may be able to set offers against criteria that mirror the criteria a user can manage on the Registration page on the Advertiser's site. These offers can be sales, discounts, and/or recommendations or announcements of new products. These offers can also be targeted against user demographic data provided as part of user's registration data as provided on the Advertiser's site.

View Reports (web)—Advertisers can view statistics on the number of matches displayed and the rating for each offer. They can also run reports on aggregate demographic data of users who responded to their offers.

Web browsers: The application preferably supports the following browsers fully or at least partially: GOOGLE CHROME, FIREFOX, INTERNET EXPLORER, SAFARI AND OPERA.

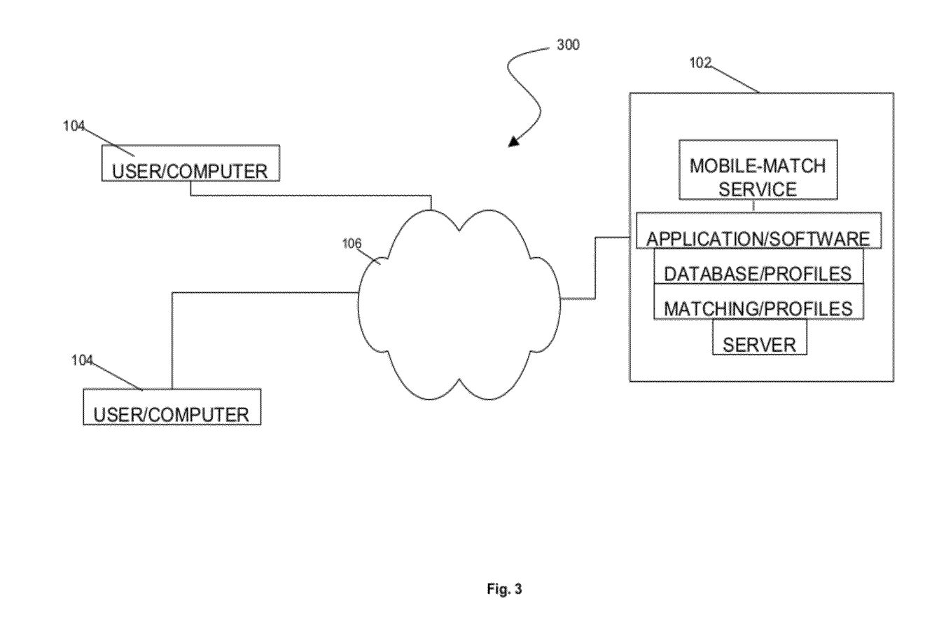

Referring again now to the drawings, FIG. 3 illustrates a high level overview 300 of interaction between computing devices 104 and information processor 102 via network 106. A user logs in on his/her computer (most likely, but could be a mobile device) through the internet he connects to our service to register/log in/create profile/manage settings. The same user connects from a mobile device to check in at a location on our service and receive/respond to matches.

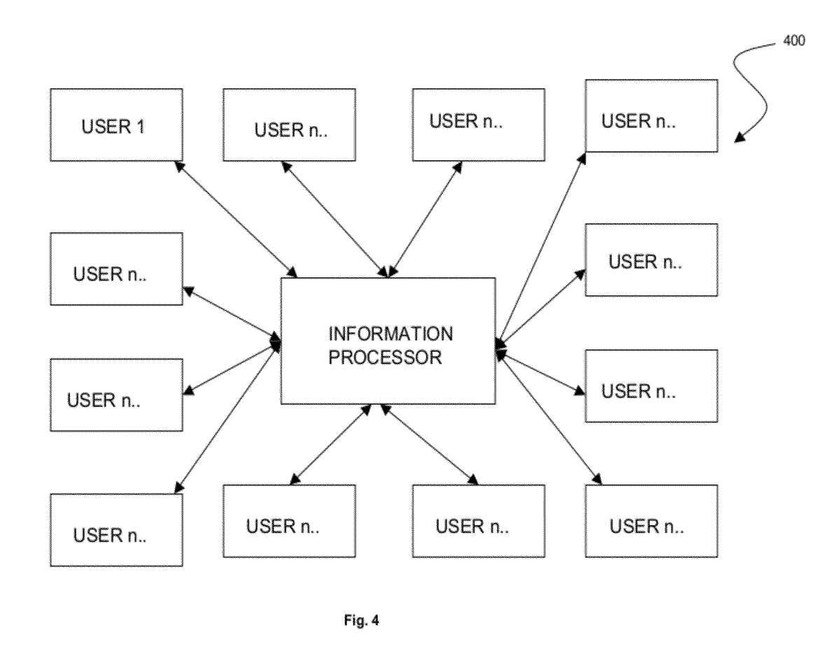

FIG. 4 shows a block diagram 400 that includes a plurality of users connected to a information processor, which may operate as a sort of hub device, in accordance with an embodiment. Preferably, and as shown in FIG. 3, there is no direct one to one communication between the users. The UserN denotes any arbitrary number of simultaneous users. Alternatively, direct one to one communication between users may be supported.

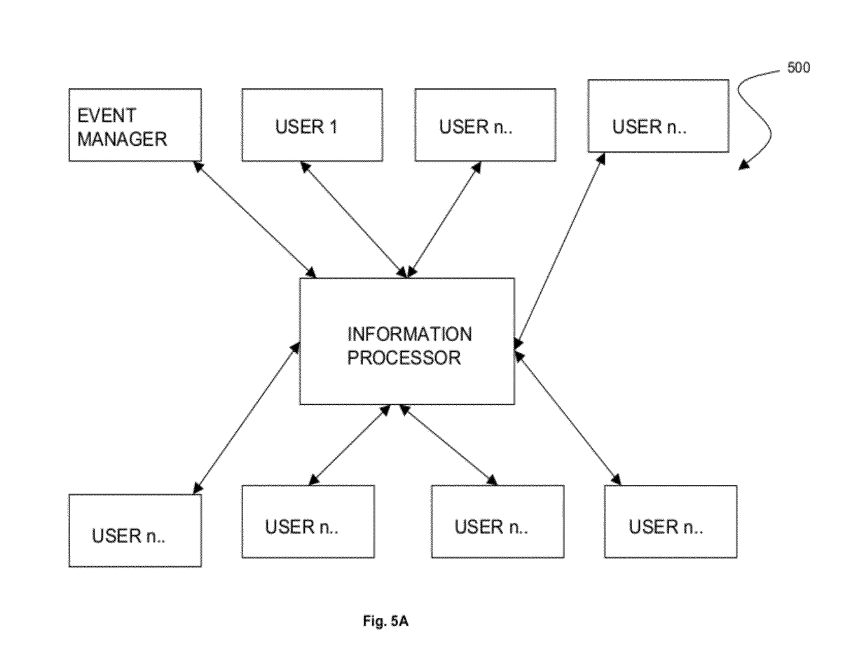

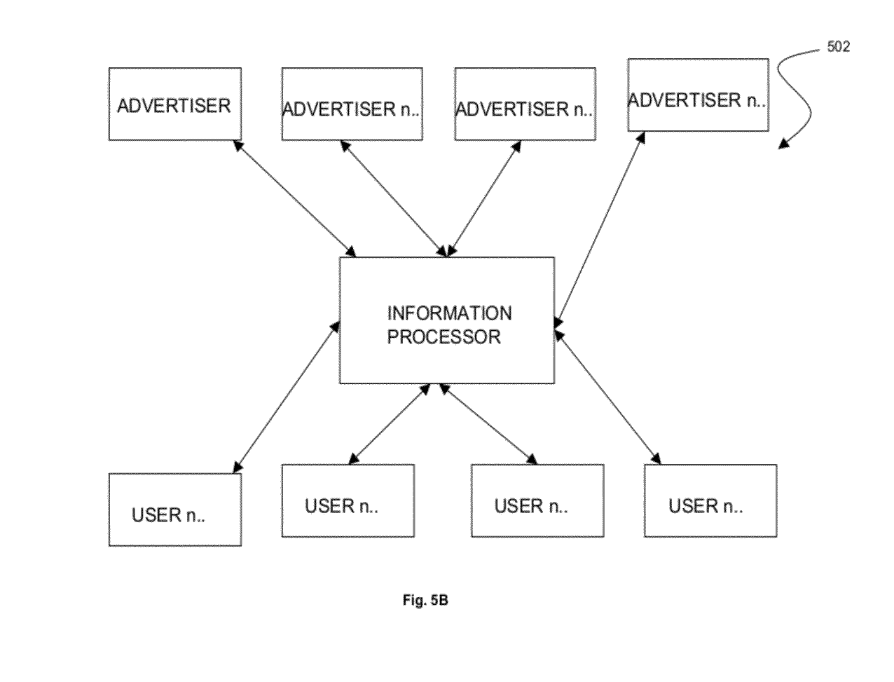

FIG. 5A is a block diagram 500 that includes an Event Manager and a plurality of users communicating over a communication network, in accordance with an embodiment.

FIG. 5B is a block diagram 502 that includes a plurality of advertisers and users connected to a hub device, in accordance with an embodiment. FIG. 5B is similar to FIG. 4, except focused on the user-to-product matches and includes advertisers and users. Again, AdvertiserN and UserN denote an arbitrary number of simultaneous users. Note that in the embodiment shown in FIG. 5B, advertisers do not have direct interaction with users, just with the service and aggregated information. Alternatively, advertisers may interact directly with users.

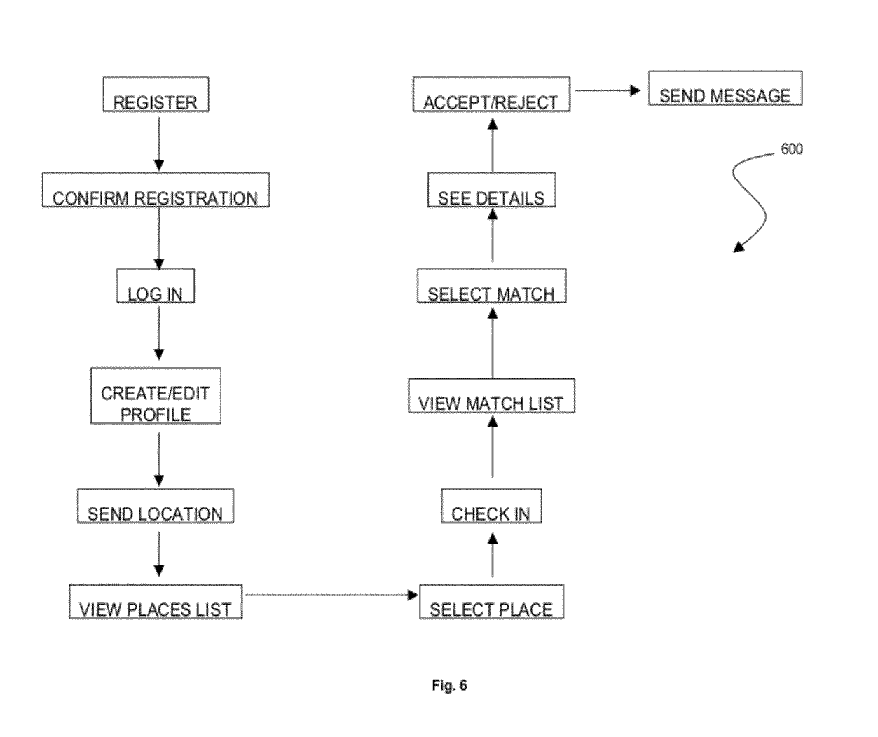

FIG. 6 is a flow chart identifying steps 600 that a user takes through their first match, in accordance with an embodiment.

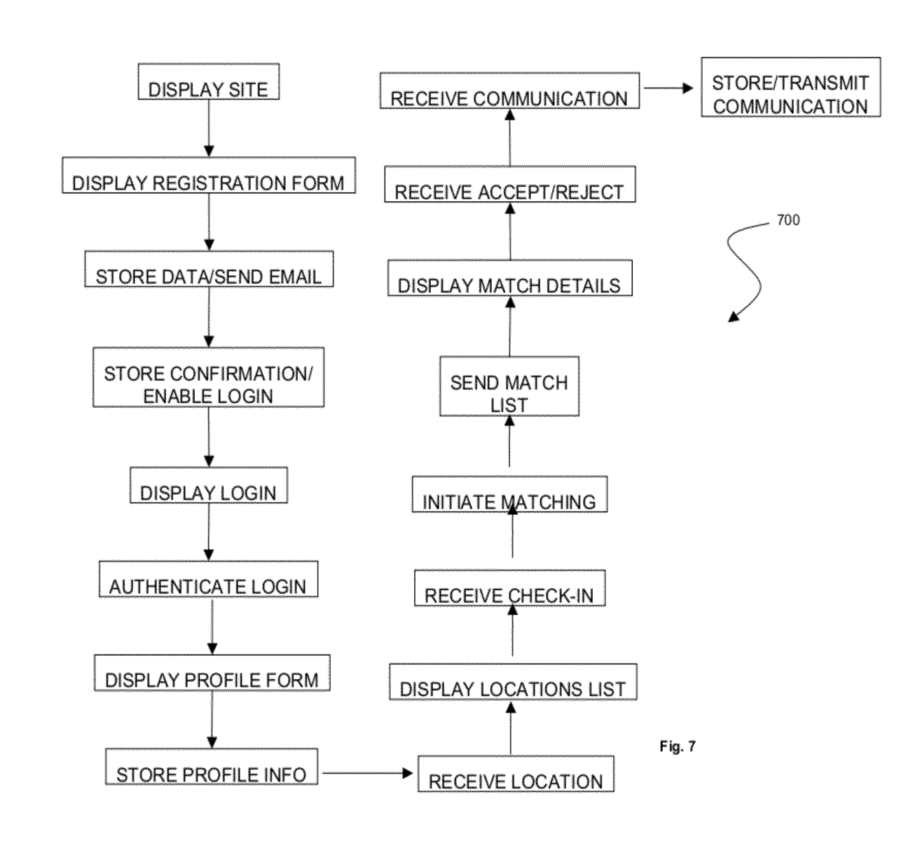

FIG. 7 is another flow chart identifying steps 700 that the system takes in response to a user from initial registration through their first match, in accordance with an embodiment.

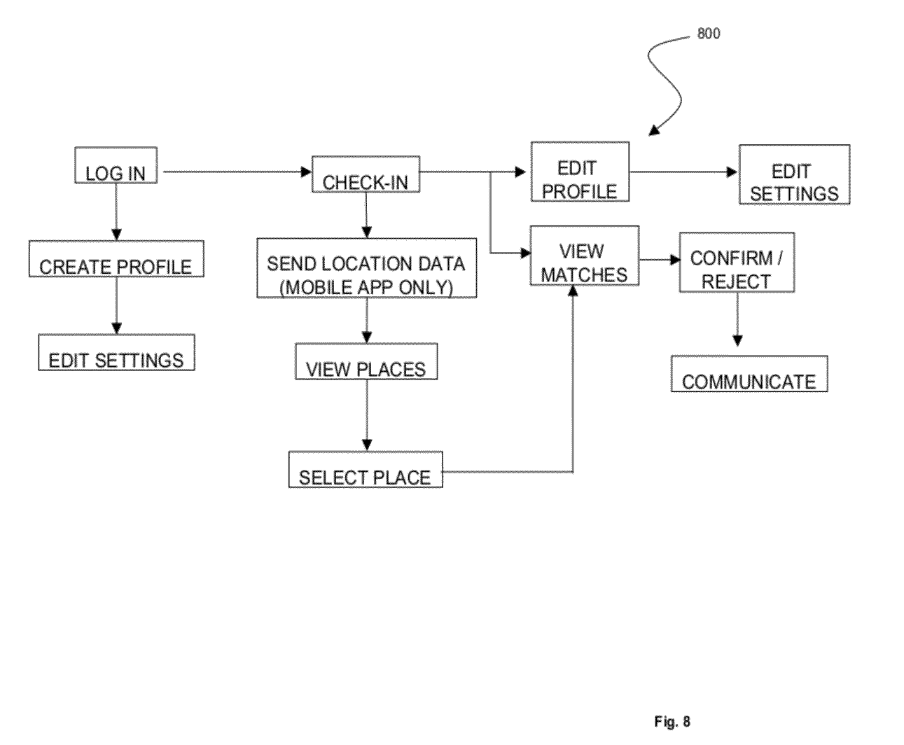

FIG. 8 illustrates steps 800 associated with use of an embodiment, after a user has logged in.

FIG. 9 illustrates a display “home” screen 900, in accordance with an embodiment. As shown in FIG. 9, users can initiate a registration process with information processor 102, or may log-in, in case they have already registered.

FIGS. 10A and 10B illustrate a user profile data entry display screen 1000, in accordance with an embodiment. Display screen 1000 provides data entry controls for a user to submit demographic, contact, interest and other information about himself/herself. In addition, data entry display screen 1000 includes sharing control section 1002, to update and/or pull information from social networking or other web sites, such as FACEBOOK, TWITTER and LINKEDIN.

FIG. 11 illustrates a notification display screen 1100 in connection with completing a user registration, in accordance with an embodiment. As illustrated in FIG. 11, an activation link is transmitted to a user's email account, which includes a link for completing a registration process with information processor 102.

FIG. 12A illustrates a user display screen 1200 in connection with a successful user log-in, in accordance with an embodiment. When a user successfully logs in to information processor 102, the user may be provided with display screen 1200 and prompted to view his/her profile, edit his/her profile, add locations, add events and find events, as shown and described herein.

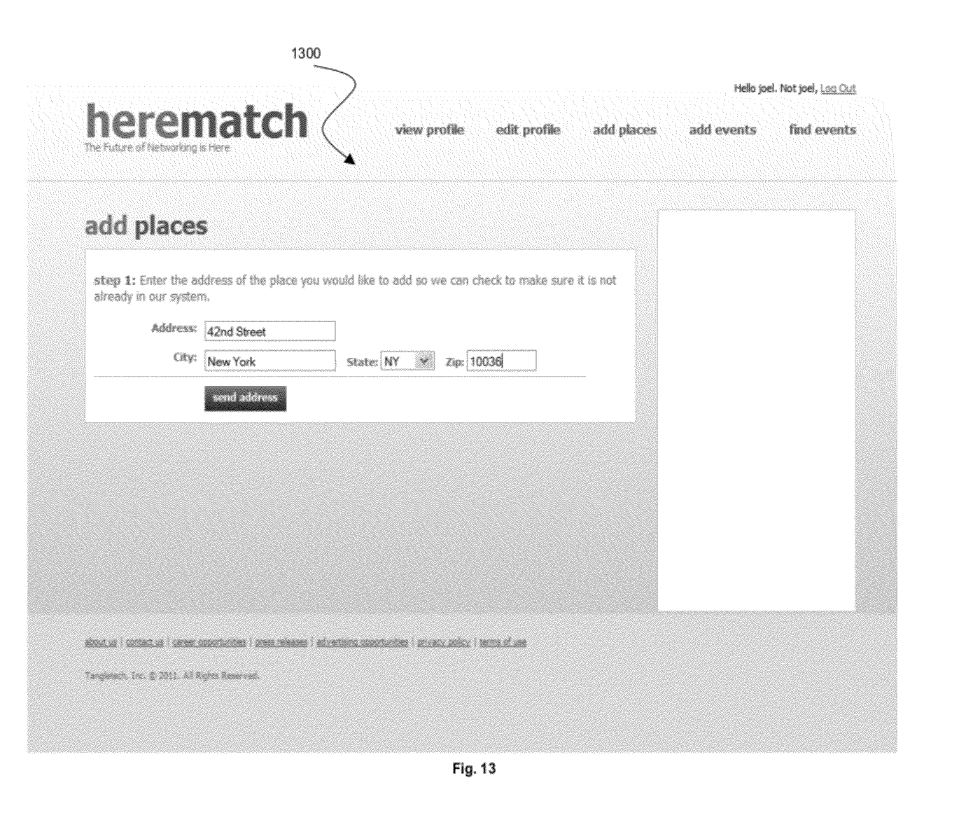

FIG. 13 illustrates an add places display screen 1300 in accordance with adding a new location for one or more events, in accordance with an embodiment. As shown in display screen 1300, the user submits address information which is used by information processor 102 to locate venues previously submitted near or at the address entered in display screen 1300.

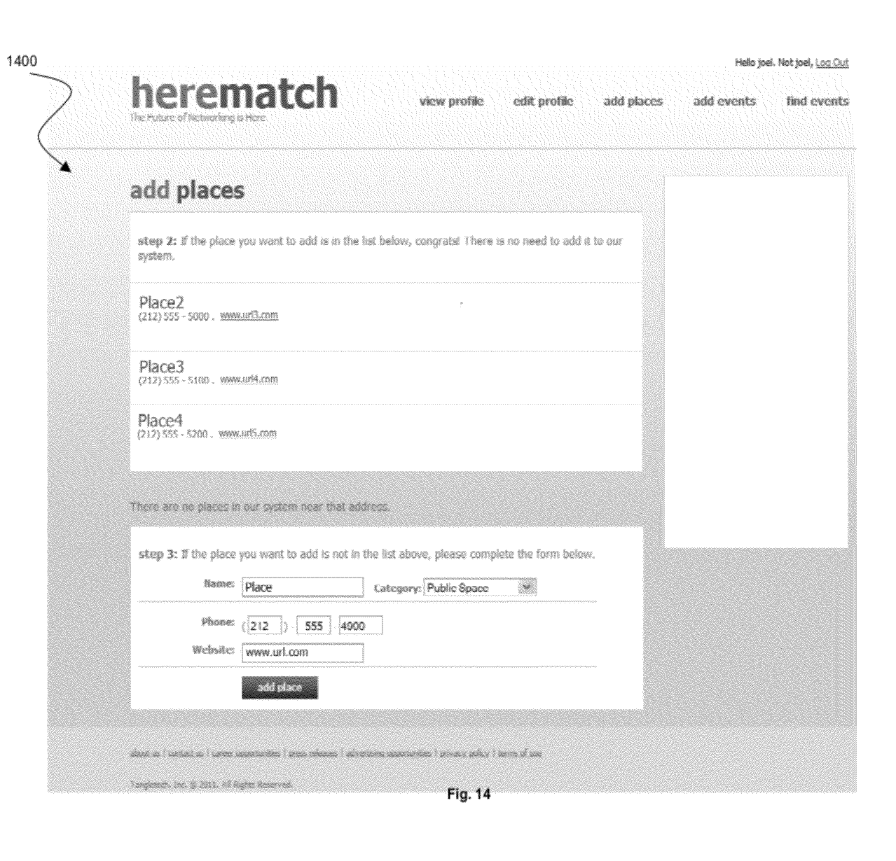

FIG. 14 illustrates another add places display screen 1400 in accordance with adding a new location for one or more events, in accordance with an embodiment. In display screen 1400, a selectable list of previously entered locations that are near or at the location entered in display screen 1300 is provided, with additional data entry controls for adding a location in the even that the location is not listed.

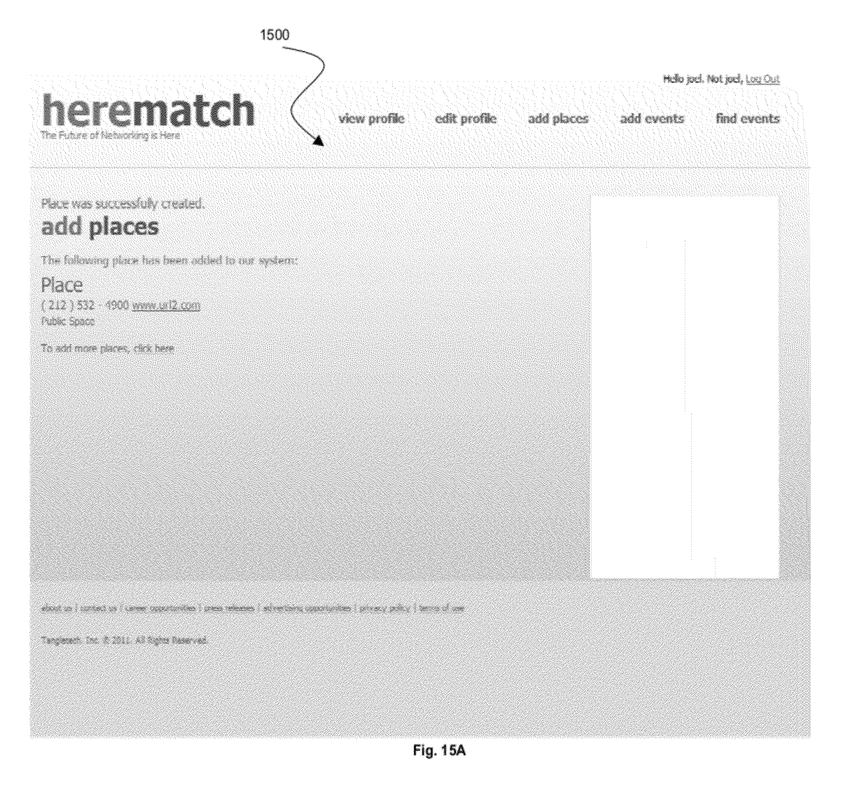

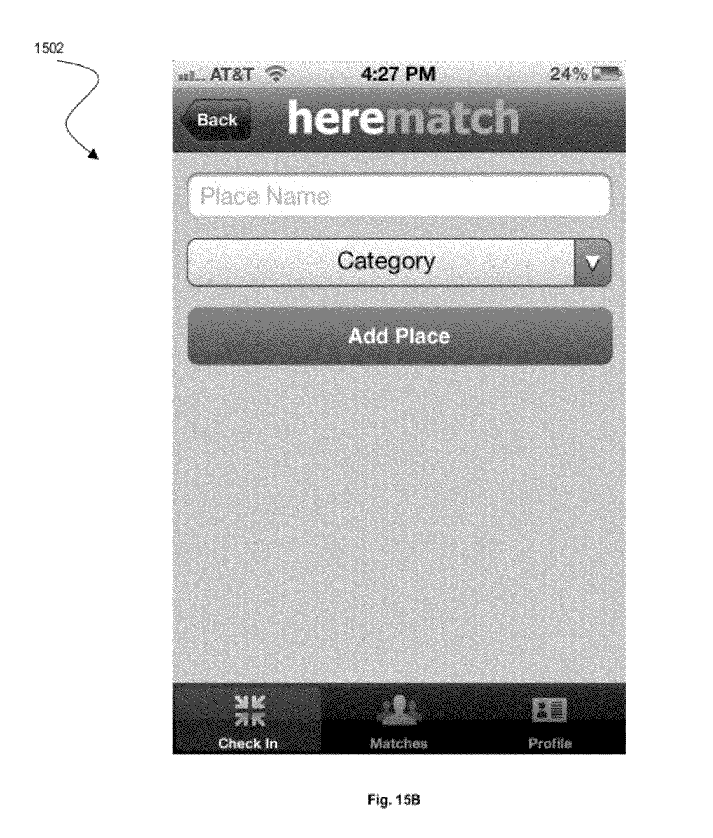

FIG. 15A illustrates a display screen 1500 illustrating a confirmation that a location was successfully added, in accordance with an embodiment. In display screen 1500, the user added “Place” as a new location for one or more events.

FIG. 15B illustrates a display screen 1502 in accordance with adding a new location for one or more events, in accordance with an embodiment. As shown in display screen 1502, an option for adding a respective category for the location.

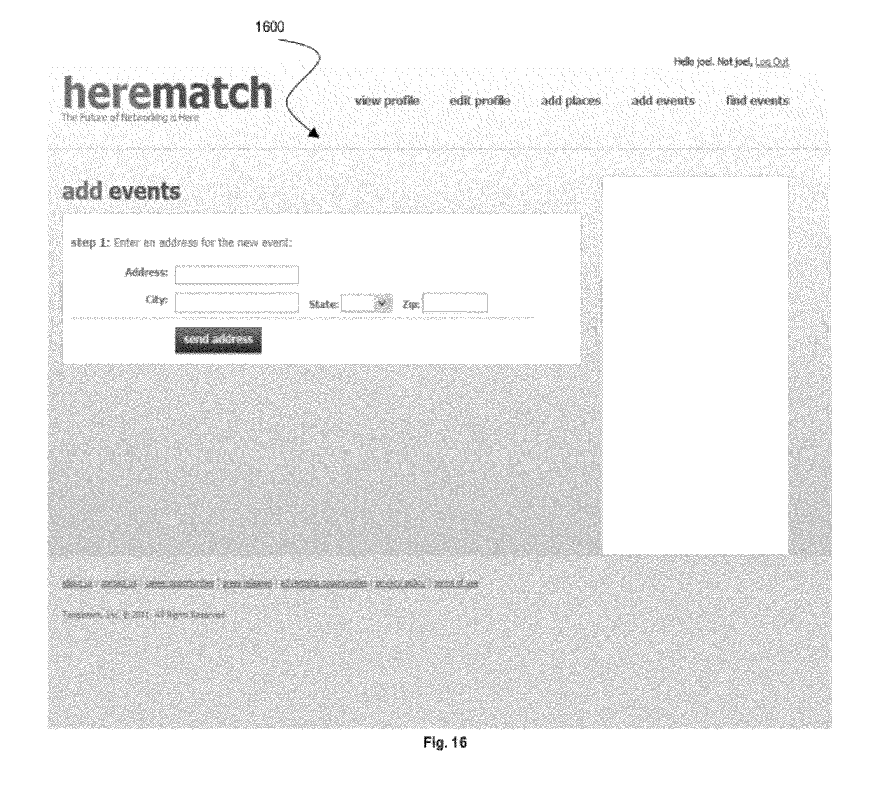

FIG. 16 illustrates an add event display screen 1600 in accordance with adding a new event, in accordance with an embodiment. In display screen 1600, data entry controls are provided for entering an address for the new event.

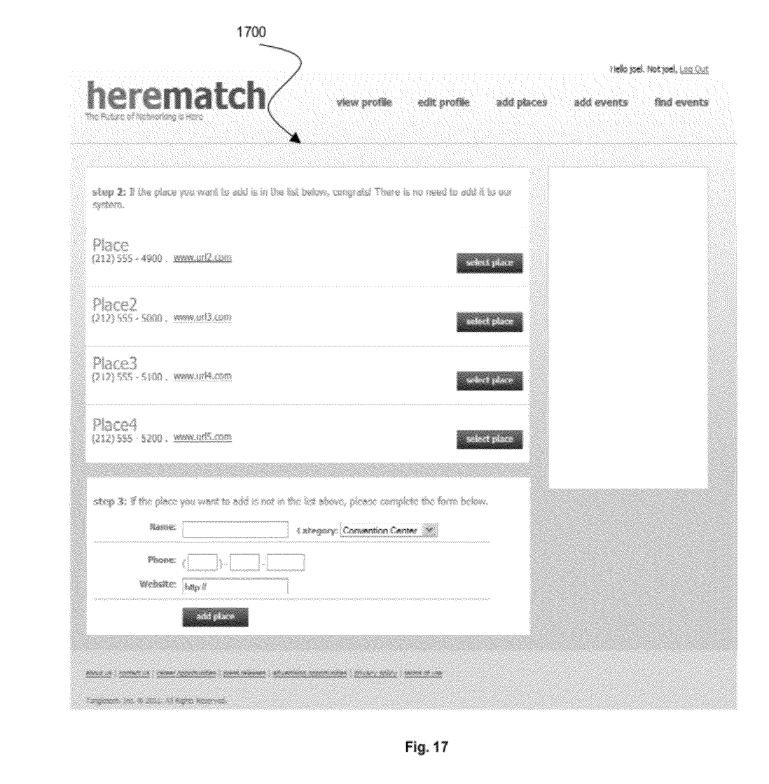

FIG. 17 illustrates an add event display screen 1700 for selecting a location for a new event, in accordance with an embodiment. In display screen 1700, a selectable list of previously entered locations that are near or at the location entered in display screen 1600 is provided, with additional data entry controls for adding a location in the even that the location is not listed.

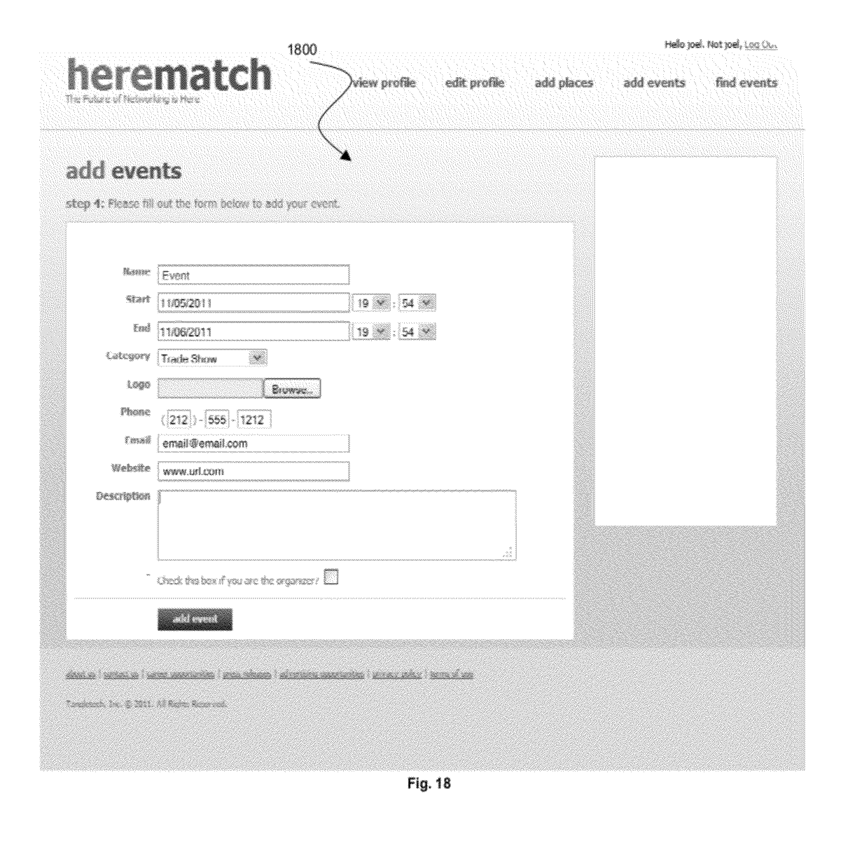

FIG. 18 illustrates another add event display screen 1800 in accordance with adding a new event, in accordance with an embodiment. In display screen 1800, a series of data entry controls are provided for a user to submit information associated with a new event. For example, the user submits the name of the event, start and end dates for the event, a category for the event, contact information (e.g., telephone, email and web site information) and a description of the new event.

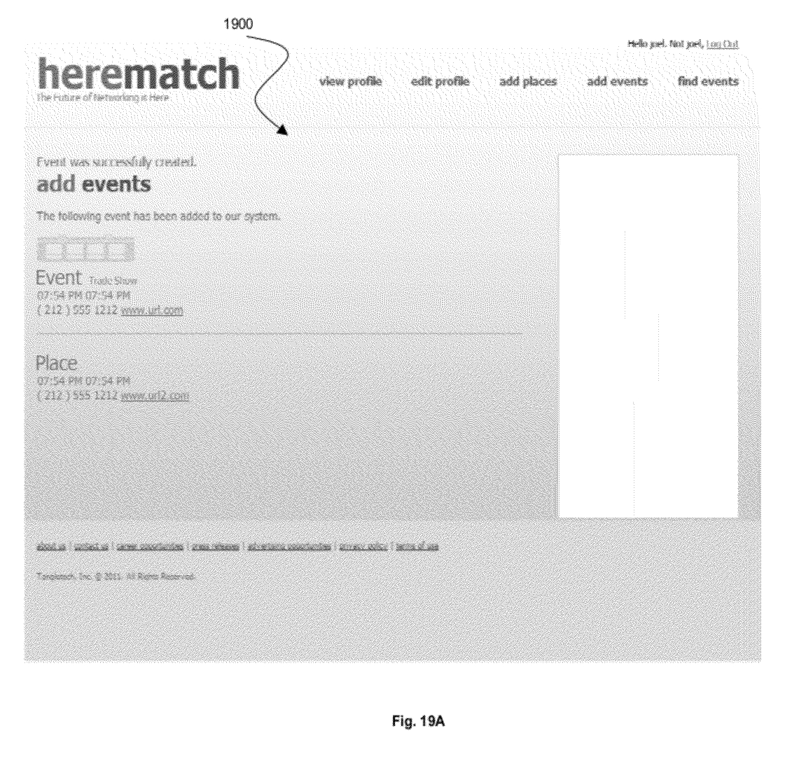

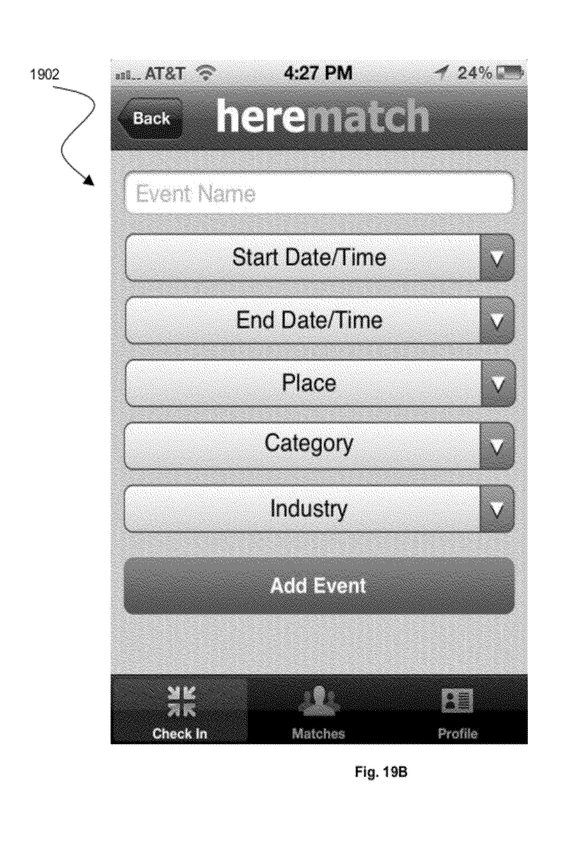

FIG. 19A illustrates a display screen 1900 illustrating a confirmation that an event was successfully added, in accordance with an embodiment. In display screen 1900, “Event” has been added to “Place.”

FIG. 19B illustrates an add event display screen 1902 in accordance with adding a new event via mobile computing device 104, in accordance with an embodiment. In display screen 1902, a series of data entry controls are provided for a user to submit information associated with a new event. For example, the user submits the name of the event, start and end dates for the event, a location of the event, a category for the event, and industry-related information. The user selects an option to add the event to formally add the event. In an embodiment, display screen 19B provides different data fields than those provided on a web browser via computing device 104 (e.g., to make it easier to add from the phone). Fields include name, start date/time, end date/time, category, industry, and location. When you click add event, the event is added to the database. If the event is occurring presently, the user who adds the event may also automatically checked in to it.

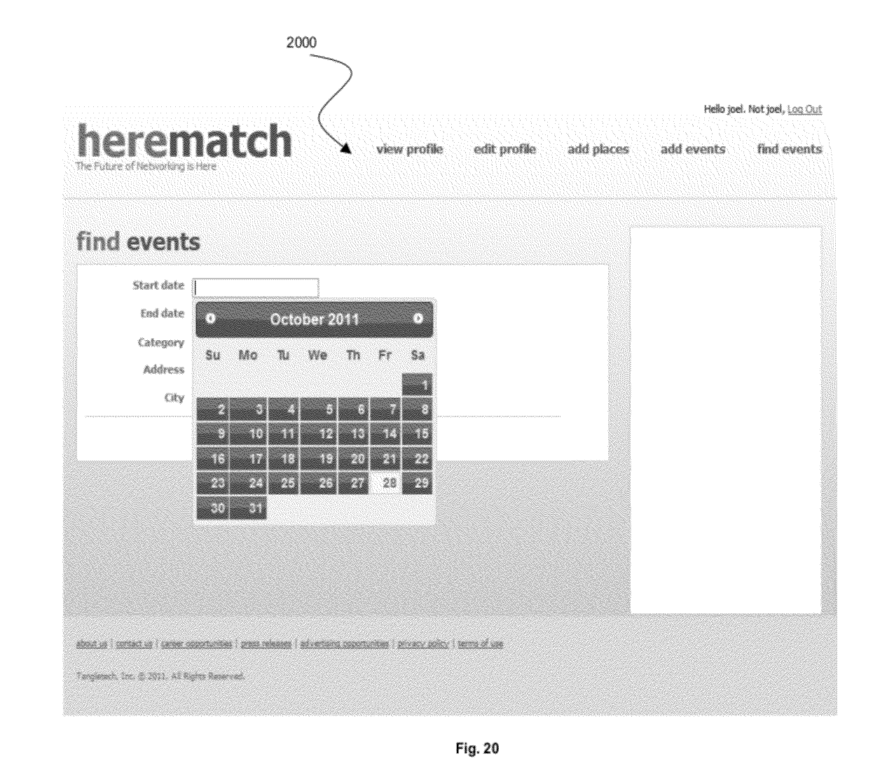

FIG. 20 illustrates a display screen 2000 illustrating a find event selection, in accordance with an embodiment. In display screen 2000, a selectable calendar month is provided for the user to select a respective starting date and/or ending date for an event, in order to find an event.

FIG. 21 illustrates a display screen 2100 provided on mobile computing device 104 that illustrates events and locations that are near a user, in accordance with an embodiment. Detailed information regarding the event(s) and/or location(s) may be provided, for example, by selecting one or more event(s) and/or location(s). Also included are tabs in a footer section in display screen 2100, which allow the user to jump to check-ins, matches, and your profile page.

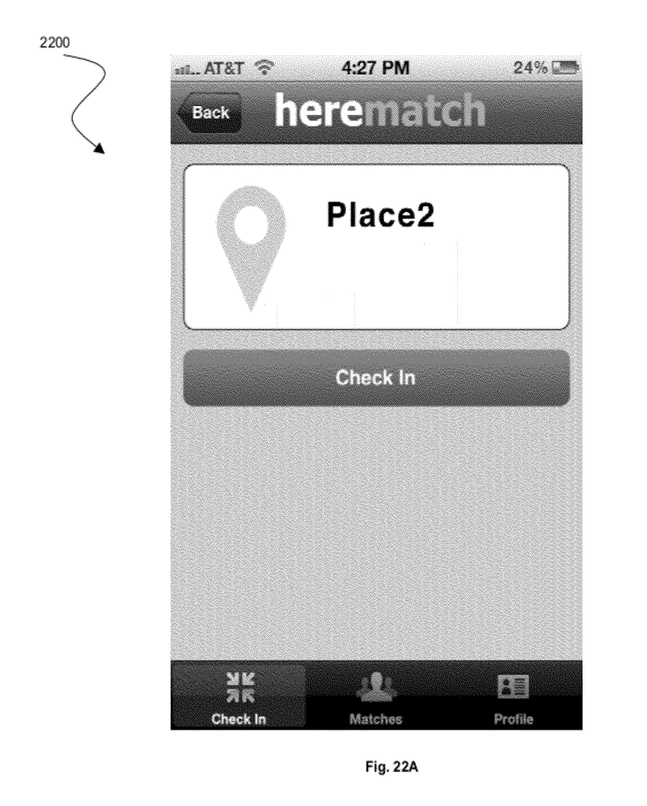

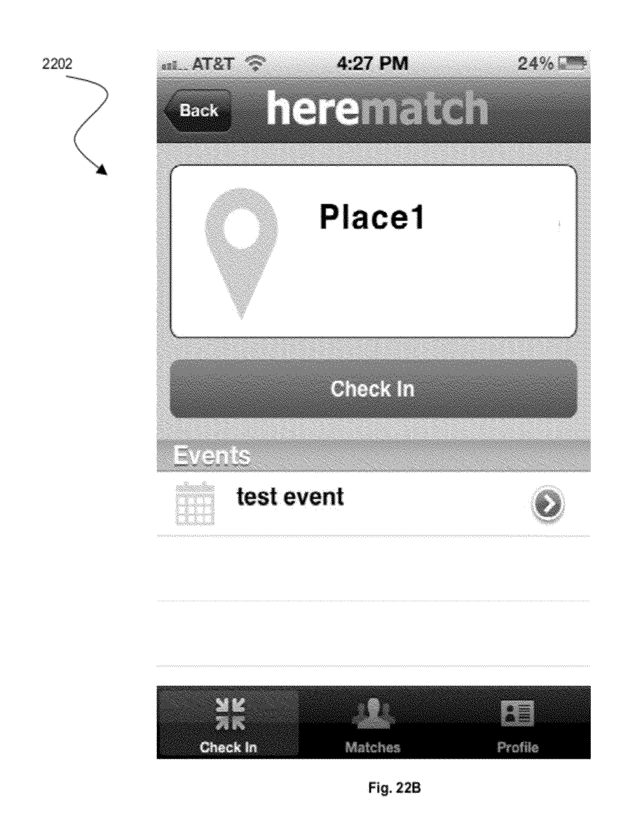

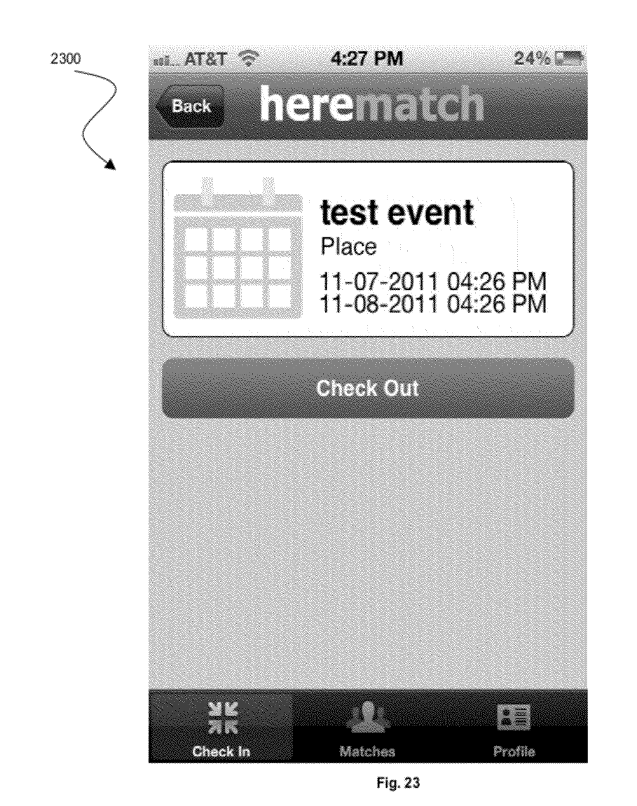

FIG. 22A illustrates a display screen 2200 provided on a mobile computing device 104 that represents a location, in accordance with an embodiment. FIG. 22B illustrates a display screen 2202 provided on mobile computing device 104 that represents a location with an event presently occurring, in accordance with an embodiment. Selecting the event (FIG. 22B) may cause event detail display screen 2300 to appear (see, for example, FIG. 23). In the example shown in FIGS. 22A and 22B, Check In button is displayed because the user is not yet checked in. If the user added the location via a mobile computing device 104, no address may be displayed, since it may not yet be provided. If a location was added via the web site, then an address may be displayed below the name of the location, such as near the top of the screen.

FIG. 23 illustrates a display screen 2300 provided on mobile computing device 104 that provides event details, in accordance with an embodiment. In the example shown in FIG. 23, a logo (e.g., showing default image), the name of the event, the location and the start and end date/times. Also provided is a check in/out button. In the example shown in FIG. 23, a checkout button is provided because the user is currently checked in. If the user was not checked in it would show “Check In” instead. In an embodiment, selecting Check In causes a Matches list display screen to appear.

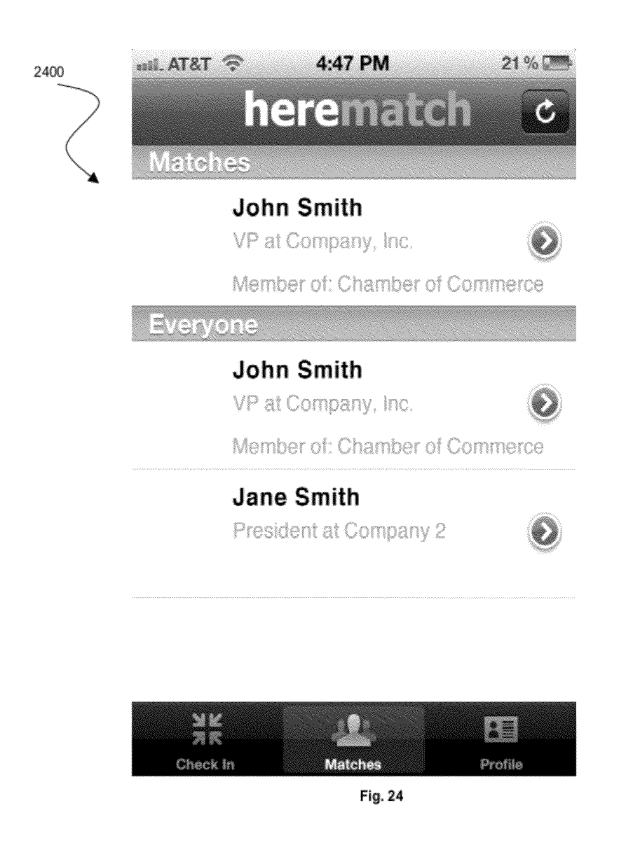

FIG. 24 illustrates a matches-list display screen 2400 provided on mobile computing device 104 in accordance with an embodiment. In the example shown in FIG. 24, a list of all users in the location that a user matches with, as well as all of the users in the room the user does not match with, may be displayed. When one respective user matches with the user (e.g., user of mobile computing device 104), the name, title and company, and the reason(s) for the match may be displayed. When a user does not match, the name, position, and company may be displayed. In an embodiment, thumbnail images of users is displayed (not shown). When an item in the list is selected, a detailed description may be displayed.

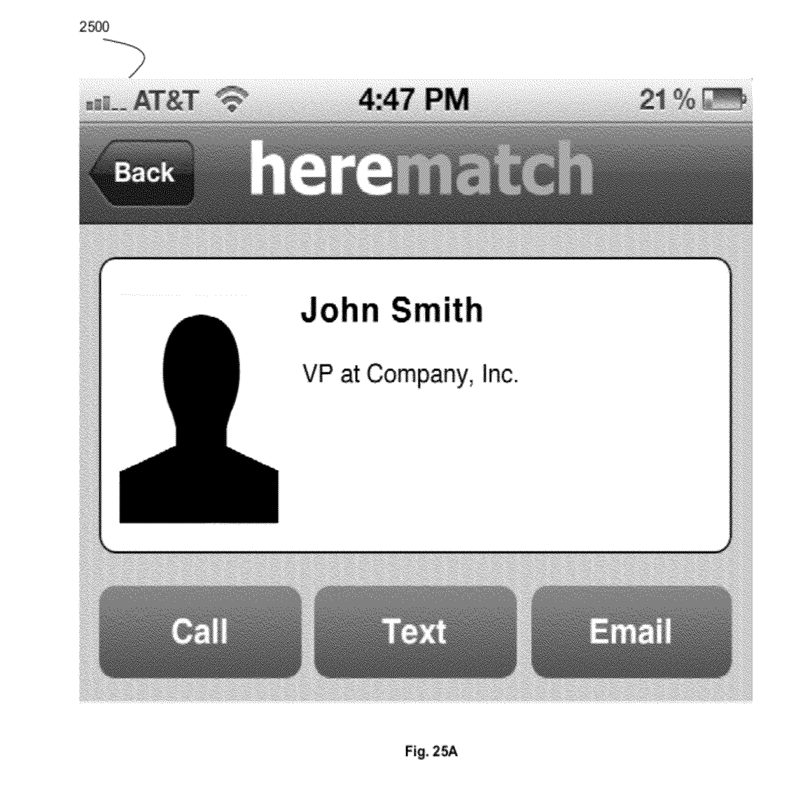

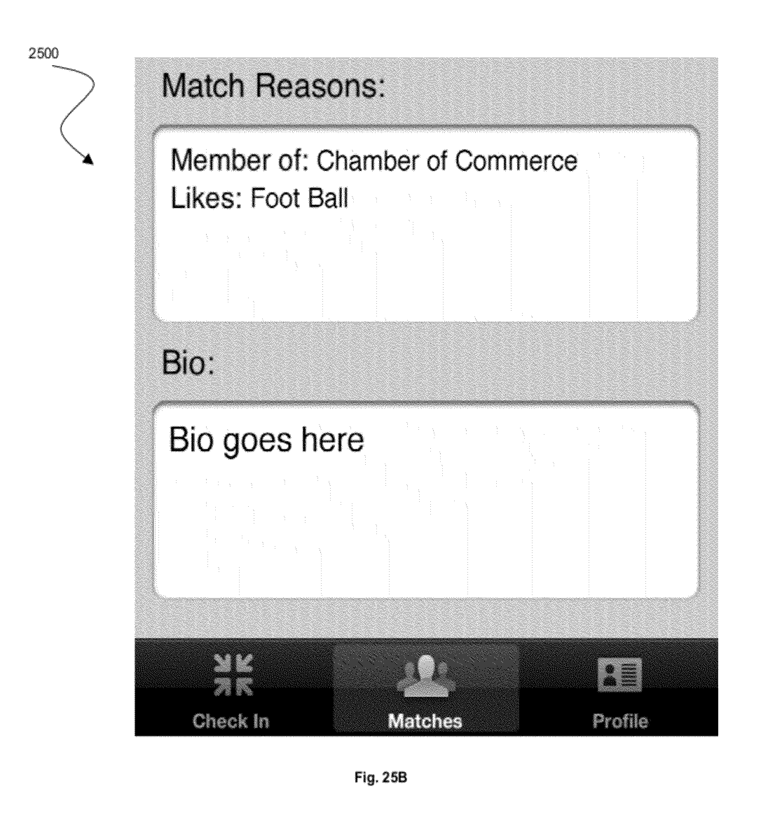

FIGS. 25A and 25B illustrate a match detail display screen 2500 that are provided in combination on mobile computing device 104 in accordance with an embodiment. FIG. 25A includes information associated with a matching user's name, position, title, industry, and location city/state. In addition, selectable options are provided for communication, e.g., telephone, text or email. In an embodiment, options are provided based on users' profiles, thereby providing appropriate context. For example if the user does not include a cell phone, the call and text options are removed. FIG. 25B includes Match Reasons, which represent at least one reason why a particular match is selected. Also provided in display screen 2500 and illustrated in FIG. 25B is the user's bio. Moreover, selectable controls for checking in, matches and user profile information are provided.

Thus, and as illustrated in FIGS. 9-25, users can add locations, events and/or select locations and events for, for example, matching with other users. Users can check-in to locations, locate others who are present, or were present, may review histories and profiles (when allowed or authorized by users), for eventual face-to-face meetings. As shown and/or described herein, users may be recommend to attend one or more events at one or more locations as a function of profile information and/or event-related information that is obtained and stored via information processor 102.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A matching method, the method comprising:
storing, in at least one database accessible to at least one information processor, user profile information representing at least a plurality of respective users;
storing, in the at least one database, location information representing at least one respective location;
receiving, from a first computing device associated with a first user, first electronic check-in information representing that the first user has checked-in to a first of the at least one respective location;
storing, in the at least one database, the first electronic check-in information associated with the first user;
receiving, from a second computing device associated with a second user, second electronic check-in information representing that the second user has checked-in to the first of the at least one respective location;
storing, in the at least one database, the second electronic check-in information;
matching, by the at least one information processor, first user profile information associated with the first user and second user profile information associated with the second user as a function of at least the first of the at least one respective location and the first and second user profile information; and
transmitting, by the at least one information processor, to one of the first computing device and the second computing device, a notification of the match.

2. The method of claim 1, wherein the first user and second user are registered users with the at least one information processor.

3. The method of claim 1, further comprising transmitting, by the at least one information processor to the first computing device and the second computing device the notification of the match, wherein the transmitting occurs substantially simultaneously.

4. The method of claim 1, further comprising receiving, by the at least one information processor, a check-out indication from at least one of the first computing device and the second computing device, wherein the check-out indication represents that the respective user of the at least one of the first computing device and the second computing device has left the first of the at least one respective location.

5. The method of claim 1, further comprising determining location information representing a location of at least one of the first computing device and the second computing device.

6. The method of claim 5, wherein the first check-in information and the second check-in information is provided by at least the location information.

7. The method of claim 1, further comprising receiving, from advertisers, advertisement content to be provided on at least one of the first computing device and the second computing device.

8. The method of claim 7, wherein the advertisement content is provided on the at least one of the first computing device and the second computing device for a fee.

9. The method of claim 1, wherein the transmitting, by the at least one information processor is performed by at least one of e-mail, short message service (SMS), messaging and paging.

10. The method of claim 1, further comprising transmitting by the at least one information processor to at least one of the first computing device and the second computing device, identification information of at least the respective user associated with the other of the at least one of the first computing device and the second computing device.

11. The method of claim 1, further comprising transmitting, by the at least one information processor to both the first computing device and the second computing device, a notification that a request for a meeting has been received.

12. The method of claim 1, further comprising receiving, by the at least one information processor, a notification that at least one of the first computing device and the second computing device has attempted to communicate with the other of the at least one first computing device and the second computing device.

13. The method of claim 1, further comprising:
receiving, by the at least one information processor from the one of the first computing device and second computing device, a response to the notification that indicates a request for a meeting between the first user and the second user; and
transmitting, by the at least one information processor to at least the other of the at least one first computing device and the second computing device, a notification that a request for a meeting has been received.

14. A system for matching, the system comprising:
one or more processor readable media;
one or more processors that are operatively coupled to the one or more processor readable media;
at least one database stored on one or more processor readable media, the at least one database including: user profile information representing at least a plurality of respective users; and location information representing at least one respective location;
the one or more processor readable media having instructions for causing the following steps to be performed by the one or more processors:
receive, from a first computing device associated with a first user, first electronic check-in information representing that the first user has checked-in to a first of the at least one respective location;
store, in the at least one database, the first electronic check-in information associated with the first user;
receive, from a second computing device associated with a second user, second electronic check-in information representing that the second user has checked-in to the first of the at least one respective location;
storing, in the at least one database, the second electronic check-in information;
match first user profile information associated with the first user and second user profile information associated with the second user as a function of at least the first of the at least one respective location and the first and second user profile information; and
transmit to one of the first computing device and the second computing device, a notification of the match.

15. The system of claim 14, wherein the first user and second user are registered users with the at least one information processor.

16. The system of claim 14, wherein the one or more processor readable media further have instructions for causing the one or more processors to: transmit, to the first computing device and the second computing device the notification of the match, wherein the transmitting occurs substantially simultaneously.

17. The system of claim 14, wherein the one or more processor readable media further have instructions for causing the one or more processors to: receive a check-out indication from at least one of the first computing device and the second computing device, wherein the check-out indication represents that the respective user of the at least one of the first computing device and the second computing device has left the first of the at least one respective location.

18. The system of claim 14, wherein the one or more processor readable media further have instructions for causing the one or more processors to: determine location information representing a location of at least one of the first computing device and the second computing device.

19. The system of claim 18, wherein the first check-in information and the second check-in information is provided by at least the location information.

20. The system of claim 14, wherein the one or more processor readable media further have instructions for causing the one or more processors to: receive, from advertisers, advertisement content to be provided on at least one of the first computing device and the second computing device.

21. The system of claim 20, wherein the advertisement content is provided on the at least one of the first computing device and the second computing device for a fee.

22. The system of claim 14, wherein the transmitting is performed by at least one of e-mail, SMS, messaging and paging.

23. The system of claim 14, wherein the one or more processor readable media further have instructions for causing the one or more processors to: transmit to at least one of the first computing device and the second computing device, identification information of at least the respective user associated with the other of the at least one of the first computing device and the second computing device.

24. The system of claim 14, wherein the one or more processor readable media further have instructions for causing the one or more processors to: transmit to both the first computing device and the second computing device, a notification that a request for a meeting has been received.

25. The system of claim 14, wherein the one or more processor readable media further have instructions for causing the one or more processors to: receive a notification that at least one of the first computing device and the second computing device has attempted to communicate with the other of the at least one first computing device and the second computing device.

26. The system of claim 14, wherein the one or more processor readable media further have instructions for causing the one or more processors to: receive from the one of the first computing device and second computing device, a response to the notification that indicates a request for a meeting between the first user and the second user; and
transmit to at least the other of the at least one first computing device and the second computing device, a notification that a request for a meeting has been received.

27. A matching method, the method comprising:
storing, in at least one database accessible to at least one information processor, user profile information representing at least a plurality of respective users;
storing, in the at least one database, location information representing one or more respective locations;
storing, in the at least one database, event information representing a plurality of respective events, wherein each of the plurality of events is respectively associated with at least one of the one or more respective locations;
receiving, from a first computing device associated with a first user, first electronic check-in information representing that the first user has checked-in to a first of the plurality of respective events;
storing, in the at least one database, the first electronic check-in information associated with the first user;
receiving, from a second computing device associated with a second user, second electronic check-in information representing that the second user has checked-in to the first of the plurality of respective events;
storing, in the at least one database, the second electronic check-in information;
matching, by the at least one information processor, first user profile information associated with the first user and second user profile information associated with the second user as a function of at least the first of the plurality of respective events and the first and second user profile information; and
transmitting, by the at least one information processor, to one of the first computing device and the second computing device, a notification of the match.

28. The method of claim 27, further comprising:
receiving, by the at least one information processor from the one of the first computing device and second computing device, a response to the notification that indicates a request for a meeting between the first user and the second user; and
transmitting, by the at least one information processor to at least the other of the at least one first computing device and the second computing device, a notification that a request for a meeting has been received.

29. The method of claim 27, further comprising transmitting, by the at least one information processor to the first computing device and the second computing device the notification of the match, wherein the transmitting occurs substantially simultaneously.

30. The method of claim 27, further comprising receiving, by the at least one information processor, a check-out indication from at least one of the first computing device and the second computing device, wherein the check-out indication represents that the respective user of the at least one of the first computing device and the second computing device has left the first of the plurality of respective events.

31. The method of claim 27, further comprising determining location information representing a respective location of at least one of the first computing device and the second computing device.

32. The method of claim 31, wherein the first check-in information and the second check-in information is provided by at least the location information.

33. The method of claim 27, further comprising receiving, from advertisers, advertisement content to be provided on at least one of the first computing device and the second computing device.

34. The method of claim 33, wherein the advertisement content is provided on the at least one of the first computing device and the second computing device for a fee.

35. The method of claim 27, further comprising transmitting by the at least one information processor to at least one of the first computing device and the second computing device, identification information of at least the respective user associated with the other of the at least one of the first computing device and the second computing device.

36. A system for matching, the system comprising:
one or more processor readable media;
one or more processors that are operatively coupled to the one or more processor readable media;
at least one database stored on one or more processor readable media, the at least one database including:
user profile information representing at least a plurality of respective users;
location information representing one or more respective locations; and
event information representing a plurality of respective events, wherein each of the plurality of events is respectively associated with at least one of the one or more respective locations;
the one or more processor readable media having instructions for causing the following steps to be performed by the one or more processors:
receive from a first computing device associated with a first user, first electronic check-in information representing that the first user has checked-in to a first of the plurality of respective events;
store in the at least one database, the first electronic check-in information associated with the first user;
receive, from a second computing device associated with a second user, second electronic check-in information representing that the second user has checked-in to the first of the plurality of respective events;
store, in the at least one database, the second electronic check-in information;
match first user profile information associated with the first user and second user profile information associated with the second user as a function of at least the first of the plurality of respective events and the first and second user profile information; and
transmit to one of the first computing device and the second computing device, a notification of the match.

37. The system of claim 36, wherein the one or more processor readable media further have instructions for causing the one or more processors to:
receive from the one of the first computing device and second computing device, a response to the notification that indicates a request for a meeting between the first user and the second user; and
transmit to at least the other of the at least one first computing device and the second computing device, a notification that a request for a meeting has been received.

38. The system of claim 36, wherein the one or more processor readable media further have instructions for causing the one or more processors to: transmit to the first computing device and the second computing device the notification of the match, wherein the transmitting occurs substantially simultaneously.

39. The system of claim 36, wherein the one or more processor readable media further have instructions for causing the one or more processors to: receive a check-out indication from at least one of the first computing device and the second computing device, wherein the check-out indication represents that the respective user of the at least one of the first computing device and the second computing device has left the first of the plurality of respective events.

40. The system of claim 36, wherein the one or more processor readable media further have instructions for causing the one or more processors to: determine location information representing a respective location of at least one of the first computing device and the second computing device.

41. The system of claim 40, wherein at least one of the first check-in information and the second check-in information is provided by at least the location information.

42. The system of claim 36, wherein the one or more processor readable media further have instructions for causing the one or more processors to: receive, from advertisers, advertisement content to be provided on at least one of the first computing device and the second computing device.

43. The system of claim 42, wherein the advertisement content is provided on the at least one of the first computing device and the second computing device for a fee.

44. The system of claim 36, wherein the one or more processor readable media further have instructions for causing the one or more processors to: transmit to at least one of the first computing device and the second computing device, identification information of at least the respective user associated with the other of the at least one of the first computing device and the second computing device.
